(19) United States
(12) Patent Application Publication
(10) Pub. No.: US 2025/0075902 A1
(43) Pub. Date: Mar. 6, 2025

(54) Continuous Char Separation Reactor

(71) Applicant: BioShare AB, Karlstad (SE)

(72) Inventors: Anna Köhler, Jonsered (SE); Jesper Aronsson, Alingsås (SE); Anton Larsson, Göteborg (SE); Christer Gustavsson, Karlstad (SE)

(73) Assignee: BioShare AB, Karlstad (SE)

(21) Appl. No.: 18/728,865

(22) PCT Filed: Jan. 24, 2023
(86) PCT No.: PCT/IB2023/050596

§ 371 Date: Jul. 13, 2024

(30) Foreign Application Priority Data
Jan. 30, 2022 (SE) 2230025-5

(51) Int. Cl. F23C 10/06; F23C 10/10; F23C 10/26; F23G 5/027; F23G 7/10

(52) U.S. Cl. CPC F23C 10/06; F23C 10/10; F23C 10/26; F23G 5/0276; F23G 7/10; F23G 2203/504

(57) ABSTRACT

A continuous char separation reactor (800) comprising a container (301) configured to contain a bed of char and bed solids and a settling zone (122) disposed within a first region of the container and configured to receive an input flow (180) comprising the char and bed solids. The settling zone (122) comprises a settling means (334) configured to segregate the received char and bed solids into a char fraction (001) having a ratio of char to bed solids that is at least 5× larger than that of the input flow (180) and a depleted portion (002) of the bed solids having a lower ratio of char to bed solids than that of the input flow.

### CROSS REFERENCE TO RELATED APPLICATIONS

The present application claims the priority benefit of Swedish patent application number 2230025-5, filed Jan. 30, 2022, the disclosure of which is incorporated by reference herein.

### BACKGROUND

### Technical Field

Various aspects provide for separating a mixed stream of particles (e.g., char and bed solids from a fluidized bed reactor) into different phases, each having an increased concentration of one type of particles as compared to the other.

### Description of Related Art

Various chemical reactions are implemented on a commercial scale using fluidized bed (FB) technology, including circulating fluidized beds (CFB) and bubbling fluidized beds (BFB). By reacting a gas and an input substance (typically a particulate solid) using a fluidized bed of bed solids, high rates of heat and mass transfer are combined to enhance reactions between the gas and the input substance under uniform, well-controlled conditions.

Commercial fluidized bed technology relies on having a well-mixed bed, in which the input substance, bed solids, and fluidization gas are thoroughly mixed with each other. As such, prior fluidized bed technology is directed toward the enhancement of mixing, increased homogeneity, and the prevention of phase separation within the bed. Segregation within the bed reduces performance, and so prior fluidized bed technology is directed toward increasing convection and turbulence, and otherwise increasing homogeneity within the reactive volume.

Fluidized bed technology is challenged by reactions that yield a condensed (e.g., solid) product that must then be separated from the bed solids. Having benefitted from a process requiring a well-mixed, homogeneous, uniform distribution of product particles among the bed solids, the artisan is faced with the challenge of separating the desirable particulate product from the bed solids.

Char and other carbonaceous derivatives of a volatilization process (e.g., pyrolysis) may be used in a variety of applications. Char derived from biomass (biochar) may be used to replace fossil carbon. Biomass may be converted to char in a fluidized bed reactor, but subsequent use of the char requires separation of the char from the bed solids.

U.S. Pat. No. 4,682,986 describes a “[p]rocess for separating catalytic coal gasification chars.” (Title)

### SUMMARY

Various aspects provide for a separation reactor configured to receive a mixed stream comprising different types of solids and separate the stream into a first phase predominantly composed of one type of solids and a second phase predominantly composed of another type of solids. For example, a fluidized bed reactor may yield a mixed stream comprising bed solids and another condensed particle phase (e.g., char, such as biochar). A separation reactor may receive this mixed stream and separate the bed solids from the biochar to yield a segregated bed, in which a portion of the bed is enriched with biochar and another portion of the bed is depleted of biochar. The portions may comprise layers within the bed. Having been separated, the different phases may be used as needed. A segregated species (e.g., char) may be reacted within the reactor and/or extracted from the reactor, according to the desired end product.

A separation reactor may comprise a settling zone comprising a settling means that fluidizes the bed in a fluidization state in which the bed is sufficiently fluidized that the particles segregate into different phases, but not so fluidized that those phases mix. A settling zone may comprise an aerated bed, a mildly (or even “barely”) fluidized bed of bed solids, and in certain cases, even a “mildly bubbling” bed, provided the phases segregate. A separation reactor may comprise a settling means that varies the fluidization energy imparted to the bed (e.g., periodically fluidizes the bed and periodically allows the bed to become unfluidized). The settling means may controllably impart more or less energy into the bed to achieve a desired average fluidization state, typically close to the minimum energy needed to transition from a fixed bed to a fluidized bed. A minimum settling energy may that which causes an appreciable decrease in the angle of repose (when the bed is activated) as compared to the angle of repose of a completely static bed.

As compared to typical fluidized beds, which have high fluidization velocities to enhance mixing, a settling zone typically has a fluidization state that prevents long-range mixing (e.g., via turbulence, bubble flow, and the like). By achieving a fluidized state without strong bubble flows, turbulence, and other “mixing” forces or disturbances, the settling zone may provide for enough particle motion that the particles segregate into discrete phases, yet not so much energy that those phases mix with each other. A settling zone may be advantageous when the different types of particles have different densities, sizes, buoyancies, entrainment velocities, and the like. As compared to the high fluidization states of typical fluidized beds, the settling zone may result in a substantially reduced entrainment of fines in the gas phase. Even a bubbling fluidized bed reactor operated at typical fluidization velocities entrains a fine fraction of particles in the gas phase (which may exit the reactor via a gas phase outlet). Such entrainment typically extends to larger particles with a circulating fluidized bed and higher fluidization velocities. With a settling zone, gas velocity above the segregated bed is typically very low (e.g., below the effective terminal velocities of those particles in the fine fraction). As such, the fine fraction may be retained in the bed (e.g., as part of a char fraction or a depleted portion, respectively). This retention of (otherwise lost) fines may enhance the efficiency of segregation (e.g., making more char available for extraction or reaction within the settling zone).

Segregation of the particles may enable the extraction of different types of particles at different rates. For example, segregated bed solids may be preferentially extracted from the settling zone at a high rate, yielding a short residence time in the settling zone, while segregated char may be extracted at a relatively lower rate (or even allowed to react without extraction), yielding a longer residence time in the settling zone. Such a configuration may be advantageous when balancing reaction kinetics. For example, in a mixed stream of hot bed solids and char, the hot bed solids (in the incoming mixed stream) may provide heat to gasify the segregated char. However, gasification kinetics may be so slow that a substantially continuous supply of hot bed solids needs to be circulated through the settling zone while segregated char gasifies. By repeatedly cycling hot bed solids into a zone in which the char remains for longer residence times, sufficient heat and time may be maintained to enable a desired reaction.

A stream comprising bed solids and char may be separated to yield a char fraction (substantially enriched in char) and a depleted portion of the bed solids (with a concomitantly reduced char concentration). While examples are described using the separation of char from bed solids, certain reactors may be used to separate other streams of mixed condensed phases having different properties (e.g., having different densities, mean particle diameters, particle size distributions, hydrodynamic drags, Geldart classifications, and the like). Such properties inform design features; char (for example) typically has a lower density than that of bed solids, and so a reactor may have a char stream outlet proximate to a top of a bed, such that a floating char fraction preferentially exits the settling zone but the depleted bed solids do not. A reactor directed toward separating solids having higher densities than the bed solids (e.g., metallic particles, oxides with higher density than the bed solids) might have a corresponding outlet proximate to a bottom of the bed. An outlet may comprise a door, gate, or other device configured to control flow rate through the outlet (and even to close the outlet), e.g., by controlling a height of the outlet and/or the height of the bed. The height and/or freeboard of the bed with respect to the bottom of the outlet may be controlled to reduce contamination.

Various aspects may include a reactor, particularly a fluidized bed reactor, configured to receive a char precursor (e.g., biomass, coal, peat, waste, various polymers or plastics) and volatilize the char precursor to form a char, such as biochar. A combustion fuel may be used to heat bed solids in a combustion reactor to form hot bed solids. The hot bed solids may be conveyed to a volatilization reactor to volatilize the char precursor to form a char. The char and bed solids may be conveyed to a separation reactor configured to separate the char from the bed solids.

By forming a product in a first fluidized bed reactor that removes a contaminant present in a precursor of the product, then separating the resulting product from the bed solids, the product may be used in applications that would be otherwise incompatible with the contaminant. For example, a precursor (e.g., PVC) may contain a contaminant (e.g., Chlorine) that is deleterious to a subsequent process. By combining a volatilization reactor (to remove the Chlorine) with a separation reactor (to remove bed solids), a char stream may be made suitable for a process that would otherwise be poisoned by the Chlorine in the PVC.

A continuous char separation reactor may comprise a container configured to contain a bed of char and bed solids. A settling zone disposed within a first region of the container may be configured to receive an input flow comprising the char and bed solids, segregate the input flow into a segregated bed comprising different phases (each correspondingly concentrated with one type of particles). One or more of the segregated phase may be discharged (e.g., an output flow of a depleted portion). The settling zone comprises a settling means configured to segregate the received char and bed solids into a bed comprising a char fraction and a depleted portion of the bed solids. The char fraction has a larger concentration of char to bed solids than that of the depleted portion and/or the input flow. A ratio of char to bed solids in the char fraction may be at least 5× larger, including at least 10× larger, including at least 50× larger by mass and/or volume than the ratio of char to bed solids in the input flow. The depleted portion comprising bed solids and having a lower ratio of char to bed solids than that of the input flow (although possibly containing some residual char) may be discharged from the settling zone via an output flow. A ratio of char to bed solids in the char fraction may be at least 50×, including at least 100× larger than the ratio of char to bed solids in the depleted portion. A phase (e.g., a depleted portion of bed solids) may be conveyed out of the settling zone. A phase (e.g., a char fraction) may be reacted within the settling zone (e.g., gasified) and/or conveyed out of the settling zone.

A settling zone may comprise a reaction zone within which one or more of the segregated species reacts. For example, a char separation reactor may comprise a gasification zone within which the segregated char gasifies (e.g., by reacting with steam) to form a gaseous phase (e.g., syngas). A settling zone may comprise one or more outlets to extract segregated species from the settling zone. A reactor may include a char stream outlet fluidically coupled to the settling zone and configured to convey at least a portion of the char fraction out of the settling zone (and typically, out of the reactor). A char stream outlet may be disposed proximate to an expected height (or other location) of the settling zone during operation, such that a char fraction floating on the depleted portion preferentially exits via the char stream outlet. A reactor need not include a char stream outlet (e.g., if the char is gasified).

A method may comprise receiving an input flow comprising first and second types of particles (e.g., bed solids and char, such as biochar) and settling the input flow to segregate the particles into a first phase (e.g., a char fraction) predominantly composed of one type of particles and a second phase (e.g., a depleted portion) predominantly composed of the other type of particles. The first phase may have a larger ratio of first to second types of particles as compared to the ratio of the input flow (e.g., at least 5× larger by mass), with the second phase correspondingly depleted in the first type of particles. The concentrations of particles in the first and second phases may be significantly different. The first phase may have at least 10×, including at least 50×, including at least 100× the concentration of first particles as compared to the second phase. For example, the first phase may be at least 90%, including at least 95%, including at least 99% of first particles by volume, while the second phase is <10%, including <5%, including <1% first particles by volume. At least one of the first and second phases may be extracted (e.g., a char fraction and/or bed solids may be extracted). A product phase may be extracted via an outlet, and a corresponding depleted portion of the bed solids may be returned to another part of the reactor (e.g., a fluidized bed reactor configured to combust a fuel or volatilize a precursor). A phase (e.g., char) may be reacted (e.g., gasified). A first reactor may be configured to form first particles, which may be conveyed to a settling zone (e.g., a char precursor may be volatilized to form char, which is conveyed to the settling zone for segregation). A fuel may be combusted to heat bed solids, which may be used in a volatilization reaction and/or in a reaction within a settling zone.

### BRIEF DESCRIPTION OF THE DRAWINGS

FIG. 1A is a schematic illustration of a separation reactor, per an embodiment.

FIG. 1B is a schematic illustration of certain sensor locations, per an embodiment.

FIG. 1C is a schematic illustration of a canted wall, per an embodiment.

FIG. 1D is a schematic illustration of a plan view of an embodiment.

FIG. 2 is a schematic illustration of certain exemplary fluidization regions, per an embodiment.

FIG. 3 is a schematic illustration of a separation reactor comprising a settling zone integrated with a volatilization zone, per an embodiment.

FIG. 4 is a schematic illustration of a separation reactor comprising a discrete volatilization zone and a settling zone, per an embodiment.

FIG. 5 is a schematic illustration of a separation reactor comprising various examples of a splashgenerator, per an embodiment.

FIG. 6 is a schematic illustration of a multistage reactor comprising a settling stage and a volatilization stage, per an embodiment.

FIG. 7 is a schematic illustration of a multistage reactor comprising a settling zone and a combustion stage, per an embodiment.

FIG. 8 is a schematic illustration of a reactor comprising a settling zone and a discrete combustion reactor, per an embodiment.

FIG. 9 is a schematic illustration of a multistage reactor, per an embodiment.

FIG. 10 is a schematic illustration of a multistage reactor, per an embodiment.

FIG. 11 is a schematic illustration of a multistage reactor, per an embodiment.

FIG. 12 is a schematic illustration of a multistage reactor, per an embodiment.

FIG. 13 is a schematic illustration of a multistage reactor, per an embodiment.

FIG. 14 is a schematic illustration of a reactor, per an embodiment.

### DETAILED DESCRIPTION

Various aspects provide for a separation reactor configured to segregate an incoming stream of mixed solids into separate fractions (e.g., a first fraction enriched in a first type of particles and a second fraction enriched in a second type of particles). A separation reactor may be combined with a volatilization reactor configured to react a precursor to form a product (e.g., in a bubbling or circulating fluidized bed reactor). A stream of mixed solids may flow from the volatilization reactor to the separation reactor, whereupon the mixed solids are segregated and separated (e.g., a product separated from bed solids). A combustion reactor configured to generate hot bed solids may be coupled to a volatilization and/or settling reactor, such that the hot bed solids are used to drive a desired reaction (e.g., a volatilization or gasification reaction). A separation reactor may comprise a settling zone within which a segregated species reacts (e.g., with an incoming gas phase).

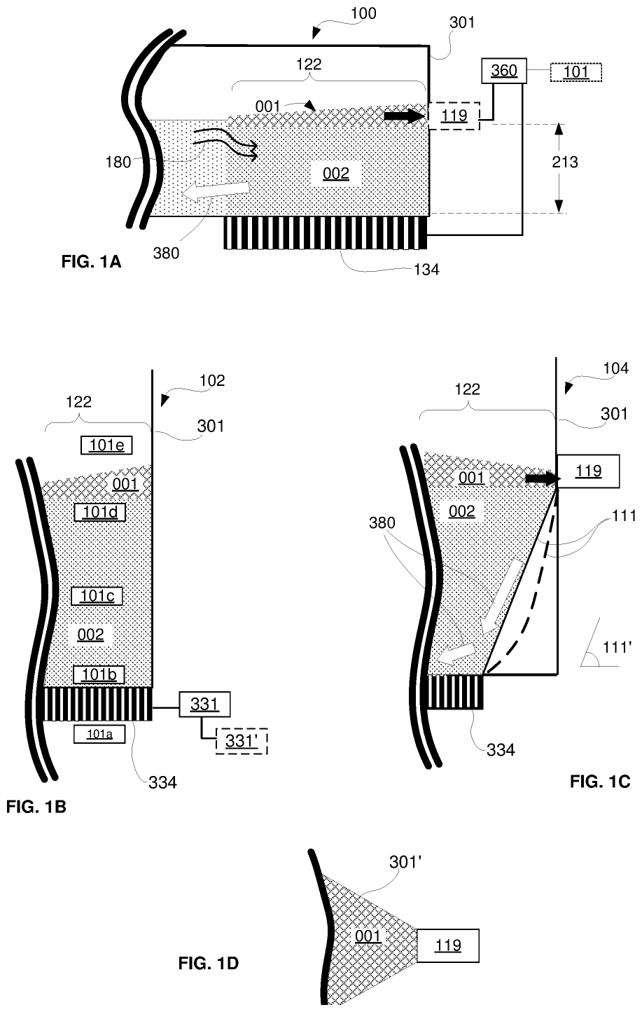

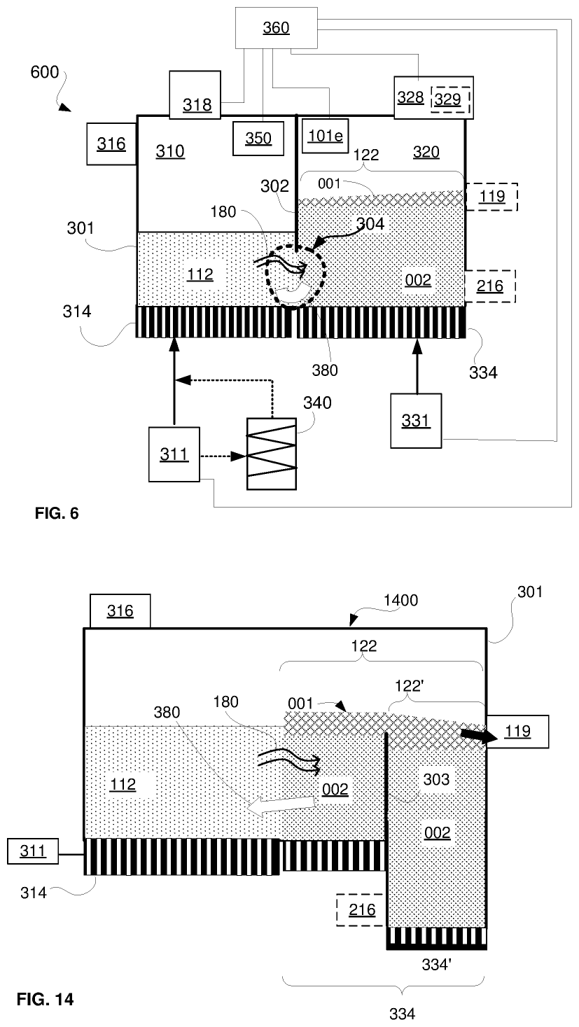

FIG. 1A is a schematic illustration of a separation reactor, per an embodiment. A separation reactor 100 may comprise a container 301 configured to contain a bed of first particles (e.g., bed solids) and second particles (e.g., char). A settling zone 122 is disposed within a first region of the container and is configured to receive an input flow 180 and output an output flow 380. Typically, the input flow comprises a mixed stream of the first and second particles (e.g., bed solids and char) to be separated from each other by the separation reactor. The settling zone 122 may segregate the input flow such that the bed comprises different phases, in these examples illustrated as a char fraction 001 having a higher concentration of one type of particles (e.g., char) and a depleted portion 002 having a lower concentration of those particles. An optional outlet (e.g., char stream outlet 119) may convey one of these condensed phases (e.g., a char stream) out of the reactor. The depleted portion 002 (e.g., bed solids having been depleted of char) may flow out of the settling zone via output flow 380. A reactor may or may not have a particular discrete outlet. For example, a separation reactor may be configured to react a segregated phase (e.g., char) to form a gas phase (e.g., comprising CO, H2 and/or CH4) which may exit the reactor via a settling gas outlet 328 (FIG. 6), which may reduce or eliminate the need for an outlet such as char stream outlet 119.

Setting zone 122 comprises a settling means 134 (e.g., near a bottom of the container) configured to activate the settling zone in a manner that causes the first particles to segregate from the second particles. A phase comprising a first type of particles may “settle out” of a phase comprising a second type of particles. Typically, the settling means imparts just enough kinetic energy to the bed that particles can move around (e.g., exchange nearest neighbors), but not so much energy that the phases of the bed mix. A settling means may comprise an actuator configured to impart mechanical energy to the settling zone, particularly a pulsed and/or periodic force. An actuator may include a vibrating, acoustic, or other pressure-inducing apparatus. A settling means may comprise a gas supply and a gas inlet configured to inject gas into the bed to induce settling. Gas may be injected via a distributor and/or a splashgenerator. Typically, a fluidization state of the bed is kept below vigorously bubbling fluidization, particularly below moderately bubbling, preferably not exceeding smooth fluidization.

The settling means is typically operated to keep at least a portion of the bed within the settling zone 122 at least slightly fluidized. An unfluidized state with substantially fixed particles typically prevents the macroscopic (e.g., centimeters of distance) transport needed to agglomerate particles into their respective phases. As opposed to prior fluidized bed technology (designed to create homogeneous, well-mixed beds to avoid segregation), a settling zone may be created with a fluidization state that is sufficiently fluid that the particles segregate into different phases, but not so fluidized that the particles mix together. Slugging, turbulent, and fast fluidization should generally be avoided. In some embodiments, a settling zone comprises a stagnant region and/or a non-fluidized region, particularly disposed adjacent to an outlet (e.g., char stream outlet 119), which may reduce cross-contamination of the extracted phases.

A settling means may be configured to vary the energy input into the settling zone (e.g., fluctuate, pulse, or oscillate the energy imparted into the settling zone). For a settling means comprising an actuator, a force, amplitude, frequency, and/or displacement of the actuator may be varied. For a settling means comprising a gas inlet, a pressure, volume, and/or velocity of the settling gas may be varied (e.g., across the distributor). A periodic variation in input energy may include a variation in amplitude and/or frequency of the energy imparted by the settling means.

In some aspects, the settling means segregates an input flow 180 comprising bed solids and char into a segregated bed. The bed may comprise a char fraction 001 having a much larger ratio of char to bed solids than the input flow 180. The char fraction may have a ratio of char to bed solids that is more than 5×, including more than 10×, including at least 50× that of the input flow. An exemplary input flow 180 may have a ratio of char to bed solids that does not exceed 5%. After the settling zone, the char fraction 001 may have a ratio of char to bed solids that is over 90%, including over 95%. A depleted portion 002 may have a correspondingly reduced concentration. Using char as an example, an enrichment ratio may be defined as the (char:solids ratio of the char fraction 001)/(char:solids ratio of the input flow 180). Various aspects may provide for an enrichment ratio that is greater than 10, at least 20, at least 50, including at least 100.

The segregated phases may be separately output (e.g., via respective outlets) and/or reacted. A segregated fraction may be output via a physical outlet from the container and/or via an output flow 380 from the settling zone itself (e.g., to an adjacent part of the bed). The settling means typically imparts less mean energy to the bed than the high fluidization energies typical of a fluidized bed reactor. As such, particles that might otherwise have been entrained in the gas phase remain in the settling zone bed (e.g., as part of char fraction 001 or depleted portion 002). The localized gas velocity in the freeboard above the settling zone is typically lower than the corresponding gas velocity above a bubbling fluidized bed (and much lower than that of a circulating fluidized bed). As a result, particles having an effective terminal velocity above the gas velocity in the freeboard of the settling zone may tend to remain in the settling zone, whereas those particles would have been entrained at typical fluidized bed gas velocities. For example, fine char particles (that would otherwise have been entrained into the gas phase in a fluidized bed) may remain in the segregated bed of the settling zone (as part of char fraction 001), providing for the reaction or extraction of these fine particles. Fine bed solids may correspondingly remain as depleted portion 002, whereas they may have been entrained in a fully fluidized bed. As a result of this reduced entrainment, the gas handling demands (e.g., need for separators, cyclones, filters) may be significantly reduced. By “capturing” fine char into char fraction 001, the efficiency of the reactor (e.g., % of char in char fraction 001 as compared to total char in the input flow) may be significantly improved.

According to the segregation properties of the particles, an outlet may be coupled to the container at a location that preferentially extracts one of the segregated streams. In FIG. 1A, reactor 100 comprises a char stream outlet 119 fluidically coupled to the settling zone 122 and configured to convey the char fraction 001 out of the settling zone. For mixed streams whose segregation yields to vertically “layered” phases, an outlet may be disposed at an appropriate height of the settling zone 122 (e.g., a heavy particles outlet near the bottom or light particles outlet near the top). In exemplary FIG. 1A, char stream outlet 119 may be configured to extract a char fraction 001 that is substantially floating on the depleted portion 002 of the bed solids, and so may be disposed at (or just above) a height 213 that is proximate to an expected top surface of the depleted portion 002 and/or a height proximate a height of the char fraction 001 such that the char fraction preferentially exits the char stream outlet. Char stream outlet 119 may comprise a gate, door, or other means configured to provide for adjustable height, such that char fraction 001 may flow out of the outlet but depleted portion 002 does not. The outlet height may be adjusted in response to changes in bed height, pressure, bed activation energies, and the like (e.g., to prevent the depleted portion from exiting via the char stream outlet).

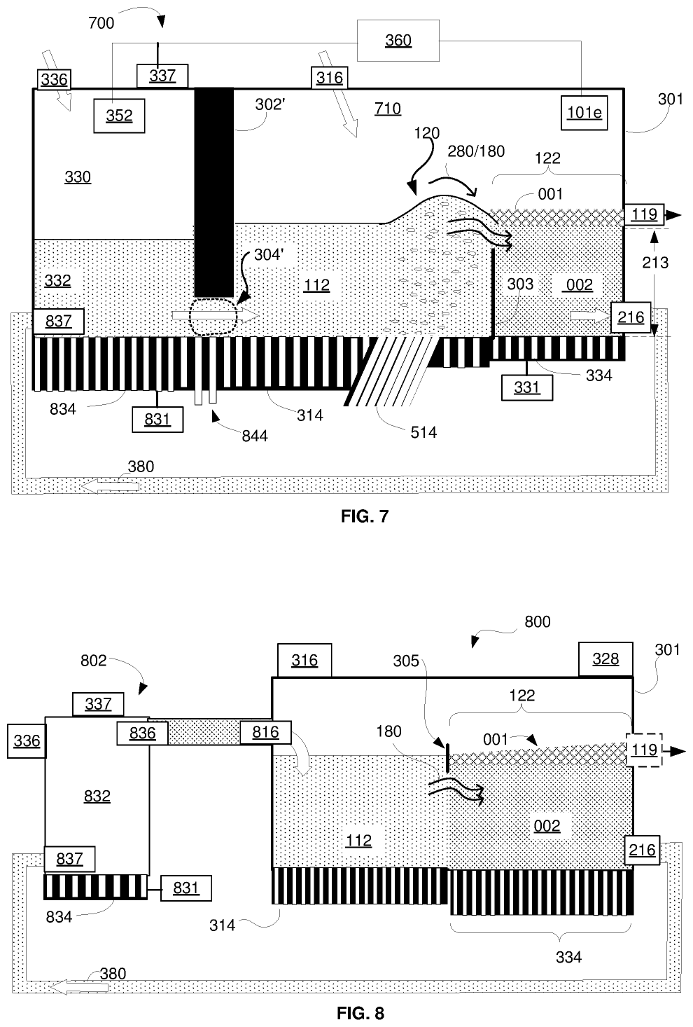

Fluidic flow into and out of the settling zone 122 from an adjacent region of the bed may be sufficient to circulate the input flow 180 into the settling zone and the output flow 380 from the settling zone. Output flow 380 may optionally be extracted from the settling zone 122 via a depleted portion outlet (not shown, see e.g., FIGS. 7-13).

A reactor may comprise one or more sensors configured to measure a parameter correlated with performance of the settling zone. In FIG. 1A, an optional sensor 101 measures a parameter that is indicative of reactor performance (e.g., a fluidization state of the settling zone, a quality of the separated phases, and the like). A sensor may sense a density, a viscosity and/or a height of the bed (e.g., a height of the settling zone), particularly the height of at least one of the char fraction and the depleted portion. A sensor may include a pressure sensor (e.g., to sense a gas pressure above the bed, a hydrostatic pressure within the bed, a manifold or other line pressure associated with a gas inlet, an exhaust pressure, and the like). A sensor may include an optical sensor (visual, IR, farIR, THz, x-ray, and the like). A sensor may include an acoustic sensor, a density sensor, a temperature sensor, and the like. A sensor may comprise an inductance, reluctance, impedance, and/or capacitance sensor (e.g., configured to measure tomography, such as ECT or EIT). A sensor may be configured to detect bed composition a property of input flow 180, a char fraction 001, depleted portion 002, and/or output flow 380. An output stream (e.g., a char stream) may be sensed (e.g., a ratio of char to bed solids output from a settling zone).

A controller 360 coupled to the sensor(s) and the settling means may control the settling means in “closed loop” fashion to ensure that the settling zone is operating at a desired fluidization state. The controller may be configured to receive the measured parameter(s) from the sensor and calculate a difference between the measured value and a desired value (e.g., associated with desired settling operation). When a difference between the measured and desired values is greater than a threshold, the controller may adjust the settling means (e.g., increasing or decreasing fluidization, as the case may be) to reduce the difference. A controller may control a volatilization zone and/or a combustion zone (infra). A settling zone may be operated “open loop” (without dynamic control of the settling zone in response to a sensor).

In some aspects, the response of one or more sensors (including a differential function incorporating the changes in responses of several sensors) may be used to sense properties of the settling zone 122 (e.g., a fluidization state of the bed). An optional controller 360 and sensor 101 may be coupled to the settling means 134 and configured to control the settling means to achieve a desired fluidization state. For example, an optical sensor scanning the top surface of the settling zone may detect bubbles, which may cause a controller to reduce the velocity of a settling gas being injected via a distributor.

An outlet may be adjustable (e.g., have an adjustable height) such as with a sliding or otherwise adjustable gate, such that the outlet may be adjusted in response to different operating conditions (e.g., closed). For example, a relative increase in height of the depleted portion 002 during operation might cause an unwanted fraction of the depleted portion to “spill over” into the char stream outlet 119. In such cases, the exit height of the char stream outlet may be raised (to exclude the depleted portion, retaining the char fraction 001). The controller may also operate the settling means to lower the height of the depleted portion (e.g., by reducing fluidization energy).

FIG. 1B is a schematic illustration of certain sensor locations, per an embodiment. An array of sensors distributed at different locations may provide localized data (typically at relatively high frequencies). An array of localized data may improve the controller's performance to control the settling zone.

Reactor 102 illustrates a settling means comprising a settling gas inlet 334 coupled to a settling gas supply 331 and configured to fluidize the settling zone 122 with a settling gas. An optional fan or pump 331′ may be implemented to increase the pressure of the settling gas supplied to the settling gas inlet (e.g., to achieve a desired pressure drop across the gas inlet). A gas inlet may comprise a distributor through which gas is injected (e.g., a distributor plate, a splashgenerator, a sparger, a bubble cap, a tuyere, a nozzle, a split nozzle, a distribution pipe, and the like). A gas inlet may be disposed proximate to a bottom of the settling zone.

A distributor may comprise one or more grid points (or grate points) at which gas is injected into the bed (e.g., holes in a flat distributor plate or sparger, nozzle, tuyere, or cap locations, and the like). One grid point may itself comprise several small gas injection orifices. For example, a grid point may comprise a nozzle having a tubular plenum and several (e.g., 3-6) orifices arranged to inject gas radially outwards from the axial center of the tubular plenum. A distribution of grid points may describe an arrangement of the grid points across the distributor of a gas inlet (e.g., in a so-called “grid”).

A plurality of sensors may be disposed at different points within a separation reactor. For example (using pressure sensors), sensor 101a may sense a manifold or other “upstream” gas pressure prior to settling gas inlet 334. Sensor 101a may be disposed in a windbox, a plenum, a manifold, a fluidization beam, and/or other volume before a gas inlet. A sensor 101b may sense pressure immediately after the gas inlet (e.g., at the bottom of the bed). A sensor 101c may sense pressure within the bed (e.g., at a “stagnant bed height” when the bed is unactivated or activated by very low settling energies). A sensor 101d may sense pressure proximate to a top of the bed (e.g., the top of the depleted portion and/or within the char fraction) when the settling zone 122 is operating. A sensor may be disposed just below, approximately at, and/or slightly above an expected height of a segregated phase (e.g., char fraction 001). A sensor 101e may sense atmospheric pressure above the bed (e.g., within the freeboard) within the settling zone 122. Reactor 102 illustrates three sensors disposed at different regions of the bed. A reactor may comprise one or two bed sensors. A reactor may comprise at least four, at least six, and even at least ten different sensors. An array of sensor data (especially from sensors gathering data at high frequencies) may enhance the identification of the point at which a bed begins to bubble.

Controller 360 (FIG. 1A) may be coupled to the sensor(s) and settling means and configured to control the fluidization state of the bed. In some aspects, closed-loop control of the settling means with the sensors may be used to keep the settling zone in a desired fluidization state. It may be advantageous to combine inputs from a plurality of bed sensors (each sensing local fluctuations in a bed property) with a controller configured to vary the energy imparted by the settling means. For example, settling gas input velocity (at a given frequency) may be varied around a putative minimum bubbling velocity Umb (e.g., from just below to just above the conditions expected to yield bubbling). The periodic increases in local pressure fluctuations due to bubble formation and transport may be used to accurately control the bed conditions to prevent vigorous bubbling and mixing. A controller may operate a settling means configured to oscillate input energy at a given frequency with sensors configured to sense fluctuations around that frequency (e.g., in a “lock-in” configuration).

A settling means (e.g., settling gas inlet 334) may be controlled to maintain the settling zone at a desired fluidization state (e.g., U/Umf) that does not result in significant mixing within the settling zone. According to the properties of the different particles, a fluidization number (U/Umf) is typically below 4, including not more than 3, including not more than 2.5, including not more than 2.0, including not more than 1.8. A fluidization number may be below 1.8, including below 1.6 including below 1.4. A fluidization number may be from about 0.2 to 1.5, including up to 1.2, including below 1. A fluidization number may be at least 0.1, including at least 0.2, including at least 0.5, including at least 0.7, including at least 0.8. For some solids a fluidization number may be at least 1.0, including at least 1.2, for solids that do not readily bubble.

Prior fluidized bed reactors are designed to minimize pressure drop across the distributor in order to minimize cost, typically by using a relatively small number of grid points, each having a relatively large size to prevent constriction. In contrast, a settling gas inlet may have a larger number of grid points having smaller sizes. As viewing a distribution of grid points (e.g., from above), an exemplary gas inlet may comprise a plurality of grid points, each grid point defining a location at which the settling gas is injected into the settling zone. A distribution of the grid points across the settling gas inlet may be at least 40 grid points/m\hat{ }2 of area (e.g., bottom area of the settling zone), including at least 50 grid points/m\hat{ }2, including at least 60/m\hat{ }2, including at least 80/m\hat{ }2. Certain distributors may have at least 100 grid points/m\hat{ }2, including at least 150 grid points/m\hat{ }2.

By reducing the size of each grid point (location at which gas is injected) and the volume of settling gas injected through each point, bubble size may be reduced. To ensure uniform bed conditions, the distance between these smaller grid points may be correspondingly reduced. For some bed solids, a large number of “small size” injection points may decrease the likelihood of bubble formation.

To fluidize the settling zone, the settling gas inlet 334 and gas supply 331 may be configured to provide for a relatively high pressure drop across the settling gas inlet (e.g., between pressure sensors located at 101a and 101b) as compared to prior reactors. The pressure drop across the settling gas inlet may be chosen in concert with an expected pressure of the gas phase above the settling zone (e.g., 101e). A first pressure drop (101a-101b) across the settling gas inlet 334 may be greater than 40% of a second pressure drop (101b-101e) between a bottom of the settling zone 122 and the gas phase above the settling zone 122. The first pressure drop may be at least 60%, including at least 80%, including at least 100%, including at least 150%, including at least 200%, of the second pressure drop. A pressure drop across the settling gas inlet may be at least 2,500 Pa, including at least 3,000 Pa, including at least 4,000 Pa.

A controller 360 (FIG. 1A) may be coupled to the sensors and configured to control at least one of the first and second pressure drops (e.g., by controlling a gas inlet, an exhaust outlet, a fan, a pump, a conveyor, a screw, a valve, and the like). A controller may control a conveyor or screw apparatus configured to deliver or extract solid material from the reactor (e.g., to remove bottom ash or deliver fuel).

FIG. 1C is a schematic illustration of a canted wall, per an embodiment. In this example, reactor 104 comprises a canted wall 111, here combined with a char stream outlet 119 and oriented to direct at least some of the depleted portion 002 away from the char stream outlet. A canted wall may be straight and/or curved (as shown schematically). Typically, canted wall 111 has an angle 111′ with respect to horizontal that is larger than the expected angle of repose of the depleted portion of the bed solids above the canted wall 111. As such, the depleted portion 002 may flow along the canted wall 111 (e.g., downward and away from the char stream outlet). Canted wall 111 may be configured to direct output flow 380 out of the settling zone (e.g., with a horizontal component and/or vertical component to a flow of bed solids down the canted wall 111). A canted wall may convert vertical momentum to horizontal momentum to increase lateral flow. A canted wall may be combined with a splashgenerator (infra) and/or other means to impart mechanical energy to the depleted portion adjacent to the wall (e.g., a vibratory or other acoustic device). Imparted energy may facilitate flow of the depleted portion 002 away from the char stream outlet. In FIG. 1C canted wall 111 is illustrated without a corresponding gas inlet. A canted wall may be combined with a gas inlet (e.g., through the wall) and/or splashgenerator (e.g., through the wall). A canted wall may be configured to direct a char fraction (e.g., toward a char stream outlet).

FIG. 1D schematically illustrates a plan view of an embodiment. A settling zone may be shaped to enhance transport of a segregated species in a certain direction. For example, a reactor comprising a char stream outlet may have walls and/or baffles configured to direct a char fraction toward the char stream outlet and/or direct the depleted portion away from the char stream outlet. FIG. 1D is a schematic illustration of a plan view of a settling zone, in which one or more tapered walls 301′ change a width of the reactor proximate to the char stream outlet. A vertical height of the char fraction 001 may decrease proximate to the char stream outlet (e.g., as char is removed). By tapering walls and/or baffles, the top height of the char fraction may be maintained at a level that maintains flow through the char stream outlet.

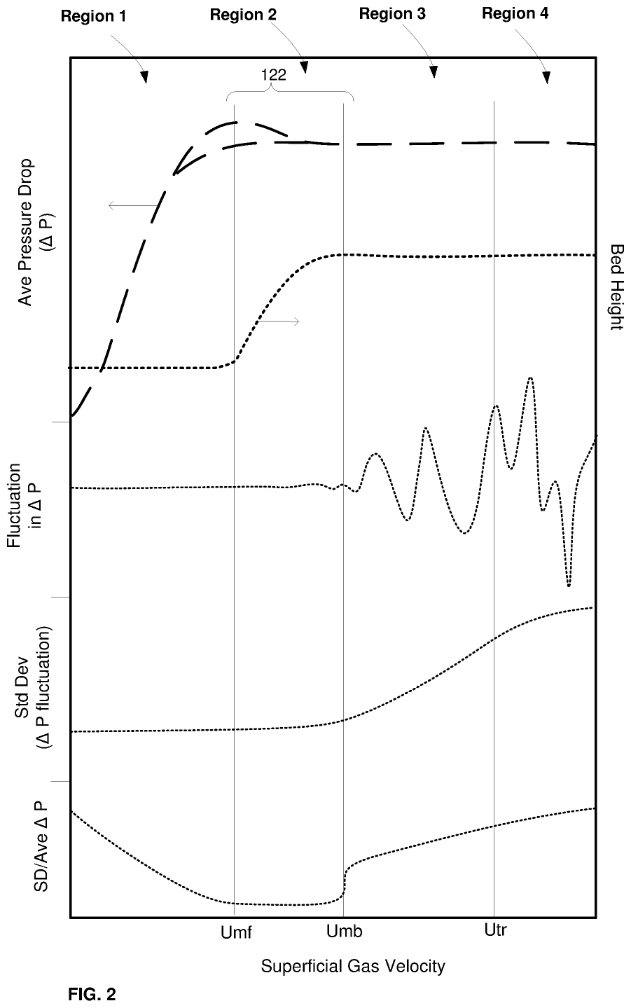

FIG. 2 is a schematic illustration of certain exemplary fluidization states and sensor responses, per an embodiment. The point at which a fluidized bed begins to bubble typically defines a maximum value for the input energy that should be imparted by the settling means. Although brief periods of bubbling and/or small bubbles may not prevent segregation, the settling means is typically operated such that the settling zone is not vigorously bubbled. Different types of particles may transition from nonfluidized to fluidized in different ways, and so different aspects of the settling zone may be implemented according to particle type (e.g., Geldart A vs. Geldart B, an expected size of the char or char precursor, and the like).

To sense the transition from nonfluidized to fluidized and/or fluidized to bubbling, sensor data may be acquired at a frequency that is high enough to measure fluctuations in the bed (e.g., above an expected “bubbling noise” frequency of the bed). A sensor may measure data at a frequency that is at least 10 Hz, including at least 20 Hz, including at least 40 Hz, at least 100 Hz. An exemplary sensor may sense data over 0.1-1 kHz. Data may be averaged or otherwise smoothed. Data from several sensors may be combined (e.g., averaged, subtracted, divided). For example, video data may be used to measure short-term height fluctuations (e.g., as waves or bubbles disrupt a top surface) and average height.

In FIG. 2, (in this case, for bed solids fluidized by a settling means comprising a gas inlet), various responses schematically illustrate the identification of certain conditions associated with a settling zone 122. Exemplary responses illustrate a change (with superficial gas velocity) in an average pressure drop across a depth of the bed, an average bed height, fluctuations in sensor data (in this case, pressure drop), and a standard deviation of these fluctuations. FIG. 2 also schematically illustrates a normalized standard deviation of the pressure fluctuations, in which the standard deviation of the pressure-drop fluctuations (at a given gas velocity) is divided by the average pressure drop at that gas velocity. Pressure drop may be measured between one or more pairs of sensors, e.g., 101b, 101c, and 101d. (FIG. 1B)

Bubbles typically yield large local fluctuations in pressure drop around a sensor. By sensing at sufficiently high frequency, these fluctuations may be measured. A plurality of measurements may be used to calculate a mean, a standard deviation, a skew, and the like. It may be advantageous to utilize at least two statistical measurements (e.g., standard deviation of fluctuations and average pressure drop) to accommodate noise. Various responses (including differential responses between two types of measurement) may be used.

FIG. 2 illustrates several exemplary regions of fluidization conditions. Region 1 may correspond to a nonfluidized bed, in which the locations of the particles are substantially fixed with respect to their nearest neighbors. Region 1 is typically characterized by a bed having a nonzero angle of repose, varying from a static angle of repose at zero fluidization velocity/energy decreasing to zero angle of repose as fluidization is approached. Region 1 may comprise an aerated bed. In Region 1, increasing gas velocity may yield increasing average pressure drop (typically linearly with velocity), but not yield an increase in bed height. The differential changes of average pressure drop (increasing with velocity) and bed height (flat with velocity) may be used to determine that the bed is not fluidized. Fluctuations in pressure drop are typically at or near zero, and so the standard deviation of pressure drop fluctuations is typically constant with increasing velocity. As average pressure drop increases (with increasing velocity), SD/Average typically decreases.

With increasing energy (e.g., higher gas velocity), the angle of repose of the bed typically decreases, approaching zero as the bed transitions from Region 1 to Region 2. Region 2 may begin at a minimum fluidization velocity (Umf) at which the bed solids begin behaving as a fluid. Increasing gas velocity beyond Umf in Region 2 typically does not yield increasing average pressure drop (and may initially yield a slightly decreasing pressure drop with increasing pressure, with hysteresis). Conversely, increasing gas velocity in Region 2 typically yields increasing bed height (e.g., linearly with velocity) as the fluidization state of the bed increases. Under these conditions, the bed is fluidized, but may be substantially free of bubbles. As such, fluctuations in pressure drop are typically very small, and so the standard deviation of fluctuations is typically small (particularly for Geldart A particles). As gas velocity is increased, fluctuations in pressure drop (and thus standard deviation) may increase slightly at higher velocities in Region 2, which may mark incipient bubbling. As both standard deviation in pressure drop fluctuations and average pressure drop are substantially constant, SD/Average may be substantially constant in Region 2.

Some solids exhibit hysteresis around Umf, in which an increase in velocity immediately after Umf yields a slight decrease in average pressure drop, but a decrease in velocity (from above Umf) does not yield a corresponding increase in average pressure drop. Hysteresis may be used to identify Umf.

For typical bed solids, bubbles eventually form at sufficiently high gas velocities. Initial bubble formation may follow a statistical process (e.g., a nonbubbling bed may have the occasional small bubble). At some point, the bubble size and population is large enough that the bed is considered “bubbling.” A minimum bubbling velocity Umb may describe a superficial gas velocity beyond which the bed behaves as a bubbling bed. Typically, increasing gas velocity beyond Umb increases the number of bubbles, bubble size, bubble agglomeration, convection and turbulence. The transition to bubbling is typically marked by a large increase in the fluctuation of sensor data (e.g., pressure fluctuations), resulting in a significant increase in the standard deviation of these data.

In Region 3 (above Umb), both average pressure drop and bed height may remain relatively constant as gas velocity increases. Fluctuations in pressure drop increase significantly with the onset of bubbling (and more so as the bed vigorously bubbles), and the magnitude of these fluctuations may increase with increasing velocity. As such, the standard deviation (e.g., of pressure drop measurements) may increase with increasing gas velocity (in some cases linearly). As average pressure drop typically remains substantially constant in Region 3, the standard deviation divided by the average may increase. There may be a discontinuity in the apparent standard deviation at Umb, after which the standard deviation may increase linearly.

As the smallest particles reach their entrainment velocities, bed height may begin to decrease with increasing velocity. In Region 4 (especially proximate to Region 3), average pressure drop and bed height may remain relatively constant. Localized fluctuations in bed conditions (e.g., pressure drop) are typically very large, as high velocity and/or large bubbles traverse the bed (e.g., the bed is “violently” bubbling). Standard deviation of the fluctuations may increase (e.g., linearly). Standard deviation divided by the average may increase. An entrainment velocity (Utr) may define a point beyond which an appreciable portion of a particular solid (bed solids, char, and/or ash) is entrained and removed from the bed via the gas phase.

Superficial gas velocity is preferably maintained below Umb to prevent bubbling in the settling zone. As such, a controller and sensors may be configured to identify the onset of bubbling and adjust the gas inlet accordingly. The gas inlet velocity (e.g., pressure, volumetric flow rate) may be varied over time to provide for a small range of velocities. The system may control this range to keep the bed within a very tight window around Umb, such that the bed is fluidized but does not mix. Such a configuration may be advantageous with bed solids for which Umb is especially close to Umf (e.g., Geldart B). A settling gas inlet may be controlled to create a superficial gas velocity that ranges from about 0.7*Umf to about 1.1*Umb, including from about 0.8*Umf to about to 1.1*Umb, including from Umf to Umb, preferably not exceeding 0.95*Umb.

In some aspects, settling zone 122 is maintained in a “smooth fluidization” state that is as close as possible to Umf (e.g., Region 2, before the onset of large bubbles). Some solids (e.g., Geldart A) are characterized by a relatively large difference between Umf and Umb, and so the use of these solids may facilitate the maintenance of a fluid state that is not bubbling. Various aspects comprise bed solids comprised of at least 10% Geldart A particles, including at least 30% Geldart A particles. Some solids (e.g., Geldart B) may have a very small difference between Umf and Umb. In such cases, the fluidization state of the settling zone may be maintained just above Umf (e.g., at the point at which bed height begins to increase with velocity.

Pressure drop and bed height measurements may be used to maintain the settling zone fluidization state proximate to Umf. For example, at velocities below Umf, the change in average pressure drop with velocity (dΔP/dVel) is positive, while the change in bed height with velocity (dH/dVel) is approximately zero, and fluctuations in both measurements are typically low. At velocities just above Umf, dΔP/dVel is (with hysteresis) zero to slightly negative, while dH/dVel is positive. Thus, the differential between these two derivatives may be used to identify Umf and the bed may be controlled to be as close to Umf as possible.

A large increase in high frequency fluctuations of pressure and/or height (as bubbling begins) may identify Umb, particularly in combination with a relatively flat response of average dΔP/dVel and dH/dVel with velocity. A settling zone may correspond to a state in which average bed height increases with velocity, average pressure drop does not increase with velocity, and a normalized standard deviation (SD/average) of one or more sensors is below a threshold (e.g., as shown at Umb in FIG. 2) A controller may continuously sweep settling means energy (e.g., gas velocity) over a range of values, monitoring sensor data to maintain the bed at incipient bubbling.

The settling means may be operated to achieve an injected gas velocity that is at least 90% of Umf, including at least 100%, including at least 120%. The settling means is typically operated such that superficial gas velocity does not exceed 3.5*Umf, including not above 3*Umf, and is typically below 2.7*Umf, including not more than 2.5*Umf. Superficial gas velocity may be controlled to be from (0.9 to 1.3) *Umf, including (1.0 to 1.2) *Umf. The settling means may be controlled to vary U over time (e.g., vary the pressure drop across the gas inlet).

By combining sensor response(s) with differential analyses (e.g., over time, over fluidization conditions, over settling means energy variation, and with respect to each other), the settling zone 122 may be maintained in a desired fluidization state. The settling zone may be sufficiently fluidized that the particles can segregate into phases, but not so fluidized that those phases mix together. Convection, turbulence, and other long-range disturbances are typically avoided in a settling zone, and gas velocity is typically kept well below that which yields turbulent fluidization, and should not exceed bubbling fluidization.

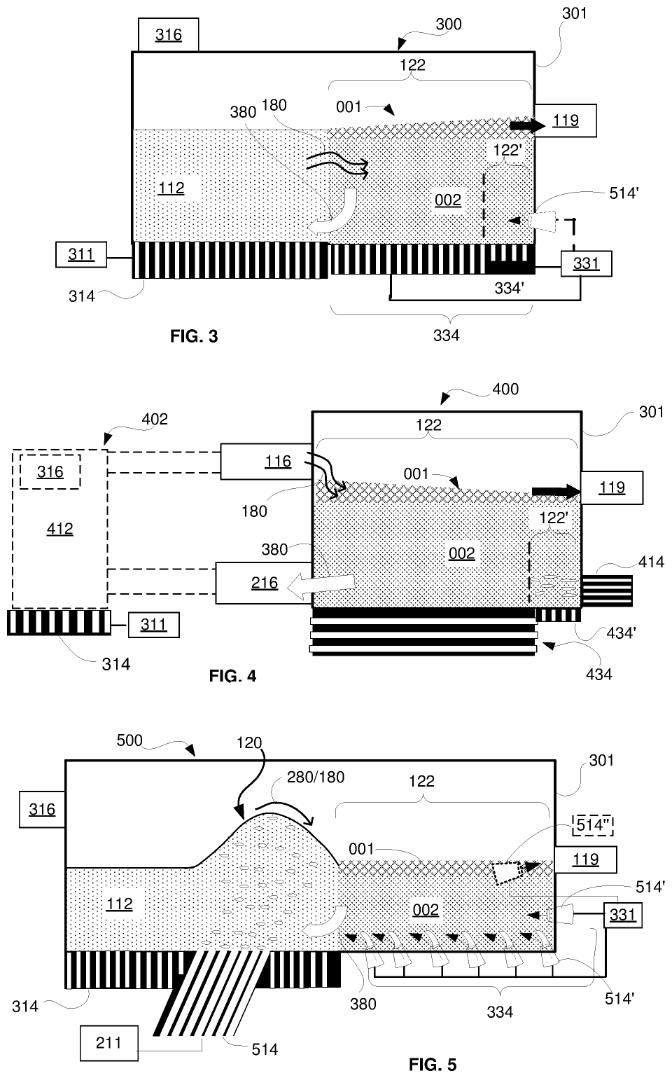

FIG. 3 is a schematic illustration of a separation reactor comprising a volatilization zone, per an embodiment. A separation reactor having a settling zone may be fluidically coupled to another reactor (e.g., a bubbling fluidized bed reactor or a circulating fluidized bed reactor) that synthesizes the condensed phase to subsequently be segregated in the settling zone. Such reactors are described herein as volatilization reactors, but their reactions need not be limited to volatilization.

A reactor may comprise a volatilization zone coupled to a char precursor inlet configured to deliver a char precursor to the volatilization zone. The volatilization zone may be configured to volatilize the char precursor to form char (e.g., biochar) using a circulating or bubbling fluidized bed. The volatilization zone may be coupled to the settling zone such that char and bed solids are conveyed to the settling zone, where they are separated. Volatilization may or may not incorporate a volatilization gas (e.g., to react with the precursor).

In reactor 300, a volatilization zone 112 and a settling zone 122 are disposed in different regions within the same container 301, such that input flow 180 and output flow 380 may flow directly between these zones. In this example, the settling means comprises a settling gas inlet 334 coupled to a settling gas supply 331 and configured to fluidize the settling zone 122 with a settling gas provided by the settling gas supply.

Reactor 300 comprises a char precursor inlet 316 configured to deliver a char (or other) precursor to a volatilization zone 112 configured to receive the precursor and volatilize (or otherwise react) the precursor to form char (or other condensed phase). Volatilization zone 112 may comprise a fluidized bed reactor in which a volatilization gas inlet 314 is configured to fluidize a bed of bed solids with a desired volatilization gas delivered by a volatilization gas supply 311 (e.g., as a bubbling fluidized bed reactor).

According to a desired reaction with the precursor, the volatilization gas may be oxidizing (e.g., air), reducing (e.g., syngas), mildly oxidizing (e.g., flue gas, steam), inert, or other gas. A volatilization zone may partially combust a fuel to yield char, such that the resulting combustion heat is used to maintain the volatilization reaction. A volatile phase may be evaporated, extracted, and/or combusted. In an embodiment, a char precursor comprising biomass is volatilized in a volatilization zone to form biochar, which is then conveyed to a settling zone for extraction via a char stream outlet.

Volatilization zone 112 is fluidically coupled to the settling zone 122 such that char (or other product) and bed solids flow from the volatilization zone 112 to the settling zone 122, where they are segregated. Input flow 180 comprising char resulting from volatilization zone 112 may be conveyed directly to settling zone 122. Output flow 380 comprising the depleted portion 002 of bed solids may be conveyed directly from the settling zone to the volatilization zone. A segregated phase (e.g., char) may be extracted via an outlet and the depleted portion of the bed solids may be returned to the volatilization zone for subsequent use.

Volatilization gas inlet 314 is typically configured to fluidize volatilization zone 112 at a fluidization velocity that is high enough to ensure mixing and homogeneous reaction of the char precursor. Such conditions may require grid points with large orifices that do not restrict flow, such that high gas volumes may be injected without incurring a large pressure drop across the gas inlet 314. Typically, the pressure drop across a volatilization gas inlet 314 is much lower than that across settling gas inlet 334. A volatilization gas inlet 314 typically has a smaller number of larger grid points than those of a settling gas inlet 334. The grid points in the volatilization zone typically have larger orifices than those of the settling gas inlet to keep pressure drop low across the volatilization gas inlet distributor. Each grid point typically delivers a higher volume of gas than the corresponding grid point in the settling zone. A distance between grid points in the volatilization zone may be larger than that in the settling zone (e.g., at least 2× at least 4×, at least 6× larger).

System cost typically increases with the required pressure drop across a gas inlet. In some cases, the “settling kinetics” are much faster than the “volatilization kinetics,” and so the relative size of the settling zone 122 may be smaller than that of the volatilization zone 112. In such cases, an increased cost (to generate higher pressure drop) may be offset by a reduction in cost due to system size. As viewed from above, a surface area of the settling zone 122 may be less that of the volatilization zone, including less than 50% of that of the volatilization zone, including below 25%, including below 10%, or even below 5%. Thus, the additional cost of increased pressure drop (across the settling gas inlet) may be offset by the reduced surface area needed to implement the settling zone itself.

FIG. 3 also illustrates a stagnant region, which may (but need not) be combined with a particular zone (e.g., a volatilization zone and/or a settling zone). In some implementations, a stagnant region may reduce an amount of depleted portion 002 that inadvertently exits via char stream outlet 119. For example, some particles (e.g., Geldart B) may have a very short transition from nonfluidized to bubbling (e.g., Umb and Umf may be very close). In such cases, it may be difficult to prevent bubbling within the settling zone while still maintaining sufficient flow for segregation. Bubbling or other disturbances (e.g., waves) may cause contamination of the char stream by the depleted portion 002 (e.g., bursting bubbles at the surface of the depleted portion may cause bed solids to flow out of char stream outlet 119). In such cases, it may be advantageous to create a small, substantially stagnant region 122′ (particularly in the depleted portion) proximate to the char stream outlet. This stagnant region may be substantially nonfluidized (e.g., Region 1 in FIG. 2) to prevent bubbles from surfacing the depleted portion proximate to the char stream outlet (which may be positioned at the stagnant bed height). A stagnant region may comprise an aerated bed (e.g., for bed solids for which aeration does not lead to disturbances in the bed).

In FIG. 3, stagnant region 122′ is implemented using a settling gas inlet 334 comprising a portion 334′ configured to deliver a different (e.g., lower) gas velocity than that delivered to the rest of the settling zone (or even no gas). A settling zone 122 may comprise a stagnant region 122′ proximate to (typically adjacent to) an outlet (e.g., char stream outlet 119). The stagnant region may have a sufficient width to block surface disturbance near the outlet yet be small enough that the char fraction 001 can traverse the stagnant region to reach the char stream outlet. The stagnant region 122′ may be nonfluidized and/or have a very small fluidization force (e.g., a superficial gas velocity that is below Umf, including from about 0.1 Umf to 0.8 Umf, including up to about 0.6 Umf. Portion 334′ may deliver a settling gas to the stagnant region 122′ at a fluidization number (U/Umf) that does not exceed 0.8, including below 0.6, including below 0.4, including below 0.2, including below 0.1.

A stagnant region may comprise a static bed (i.e., zero fluidization gas velocity or no continuous mechanical energy input). For various embodiments (particularly with substantially static stagnant regions), an optional splashgenerator 514′ (FIG. 5) or 414 (FIG. 4) may be used to periodically “break up” the bottom of depleted portion 002 in the stagnant region 122′. The splashgenerator may be disposed vertically and/or horizontally. A splashgenerator may be configured to preferentially impart a directed, aligned, relatively high-energy momentum to a localized portion of the bed (e.g., the depleted portion, output flow 380, out of the settling zone, and/or out of the stagnant region), particularly without substantively affecting the char fraction.

FIG. 4 illustrates a separation reactor comprising a volatilization zone, per an embodiment. In this example, the volatilization zone and settling zones are disposed in different containers, such that discrete reactors are coupled by inlets and outlets that provide for the transfer of inlet flow 180 and outlet flow 380 between the reactors.

In this example, reactor 400 comprises a settling zone 122 actuated by a mechanical settling means 434 (e.g., a vibrating plate, an acoustic or other pressure-wave generating device, and similar actuators). Reactor 400 may comprise a splashgenerator 414 (in this example, directed horizontally) which generates high amplitude pressure waves (in this case, proximate to a bottom of the depleted portion 002). A splashgenerator is typically configured to impart a directed, aligned momentum to a portion of the bed solids (e.g., using high velocity jets of gas, large wave oscillations, acoustic pressure/pulses, and the like). In this example, the splashgenerator may enhance the transport of the output flow (380) from the settling zone 122.

Reactor 400 may comprise a discrete volatilization reactor 402 comprising a volatilization zone 412 coupled to a precursor inlet (e.g., char precursor inlet 316) and configured to react a precursor (e.g., char precursor) to form a condensed product (e.g., biochar). Volatilization zone 412 may be configured as a circulating fluidized bed reactor fluidized by volatilization gas inlet 314 coupled to a volatilization gas supply 311 configured to supply a volatilization gas. A char stream inlet 116 may couple the volatilization zone 412 to the settling zone 122, such that the input flow 180 is delivered from the volatilization reactor 402 to the container 301 via the char stream inlet 116 for segregation and separation. A corresponding depleted portion outlet 216 may couple the settling zone 122 to the volatilization reactor 402, such that an output flow 380 comprising the depleted portion 002 of bed solids returns to the volatilization zone 412.

Various zones may be implemented using fluidized bed reactors. In some cases, the segregation properties of the settling zone are used to select preferred bed solids properties (e.g., bed solids that are easily segregated from char), and these properties may lend themselves to certain types of volatilization reactors. A bubbling fluidized bed might use solids having a mean particle diameter from about 500 microns to 1500 microns (including up to 1200 microns, e.g., Geldart B, even approaching Geldart D), while a circulating fluidized bed might use bed solids having a mean particle diameter from about 50 microns to about 600 microns (e.g., 100-550 microns, e.g., Geldart A to B). In some conditions, Geldart A solids may have a relatively large difference between Umf and Umb (the superficial gas velocity at which bubbling begins), which may facilitate easier control of the settling zone to maintain a fluidization state in Region 2 (FIG. 2). In an embodiment, a discrete circulating fluidized bed reactor 402 comprising volatilization zone 412 (e.g., with Geldart A or A-B bed solids) is coupled to a separation reactor comprising settling zone 122 comprising a gas inlet 334 (FIG. 3). The gas inlet may be operated to fluidize the bed within the settling zone at a superficial gas velocity that is at least Umf but does not exceed Umb. A volatilization zone comprising a circulating fluidized bed may be coupled directly to a settling zone.

A fluidized bed reactor comprising a volatilization zone 112/412 is typically operated such that the volatilization zone is in a highly fluidized state (e.g., at least vigorously bubbling, frothing, or slugging, including at least turbulent fluidization or even fast fluidization, including pneumatic transport). As compared to a settling zone, relatively high gas flow rates may be used to ensure uniform kinetics, tightly controlled temperatures, and/or complete reaction of the precursor to form the desired product. Convection, mixing, and macroscopic transport are typically maximized in a volatilization zone (subject to gas contact limitations), whereas they are typically minimized in a settling zone.

FIG. 4 also provides an exemplary illustration of a settling zone comprising a stagnant region 122′, which may be created proximate to char stream outlet 119. In this example, settling means 434 comprises a portion 434′ configured to activate the bed at a lower energy than that of the rest of the settling zone (including no energy) to generate a stagnant region 122′ (e.g., in the depleted portion). A stagnant region may prevent waves, bubbles, and the like proximate to the char stream outlet 119, which may reduce contamination of the char stream. When implemented with a stagnant region, a splashgenerator (e.g., splashgenerator 414) may be used to periodically disrupt or otherwise decompose the stagnant region (e.g., pushing bed solids out of the stagnant region). Portions 334′ (FIGS. 3) and 434′ and/or various splashgenerators may be coupled to one or more sensors and/or a controller (FIGS. 1A, 1B, 6) to control the stagnant region to achieve a desired bed state.

FIG. 5 is a schematic illustration of a separation reactor comprising various examples of a splashgenerator, per an embodiment. A splashgenerator may be operated to enhance long-range transport within a bed (acting on mixed and/or segregated species). A splashgenerator may also be operated as a settling means. A splashgenerator may be coupled to a transport gas supply 211 and configured to inject high momentum injections of transport gas into the bed (e.g., from one zone to another or within a zone). A splashgenerator may comprise jet nozzles configured to inject aligned, substantially parallel jets of transport gas. The nozzles may be horizontal and/or vertical, and are typically designed to generate jets rather than fluidization. A splashgenerator may be configured to inject a transport gas into, out of, and/or over the bed at a velocity, pressure, and/or flow rate that is higher than the corresponding velocity/pressure/flowrate of at least one gas inlet (particularly a gas inlet 314 configured to fluidize a volatilization zone), including at least 2×, at least 3×, at least 5×, at least 10× higher. The gas and/or temperature injected by the splashgenerator may be the same or different as the fluidizing gas(es) of other gas inlet(s). The momentum imparted by the splashgenerator may be used to control convection, circulation, heat transfer, bed uniformity, fluidization state, stirring, and the like, and may be used to increase flow of an input flow 180 and/or an output flow 380. A splashgenerator may transport solids relatively long distances within/above the bed (e.g., at least 20 cm, including at least 40 cm, including at least 1 m).

A splashgenerator may be used to preferentially direct a segregated char fraction in a desired direction (e.g., toward a char stream outlet) without substantially acting on the depleted portion. A splashgenerator may be used to preferentially direct a depleted portion in a desired direction (e.g., output flow 380, away from a settling zone, out of a stagnant region, toward a depleted portion outlet, and the like) without acting on the char fraction. Long distances generally require more energy, which may benefit from the use of pulsed splashes. A splashgenerator may create large waves of bed solids (e.g., having an amplitude larger than 20% of, including 50% of, including 80% of, the fluidized bed height). A reactor may comprise a plurality of splashgenerators. FIG. 5 illustrates several options, which may be implemented together or independently. In exemplary reactor 500, a first splashgenerator 514 is configured to enhance transport of mixed species within the bed (in this example, from volatilization zone 112 to settling zone 122), a second splashgenerator 514′ is configured as a settling means and/or to enhance transport of the depleted portion 002 out of the settling zone, and a third splashgenerator 514″ is configured to enhance transport of the char fraction 001 out of the settling zone (in this example via the char stream outlet). In this example, splashgenerator 514 is oriented at an angle, to provide a momentum that is at least partially horizontal and partially vertical, to direct input flow 180 upward and toward settling zone 122, such that the mixed flow is preferentially directed toward the top of the settling zone.

A splashgenerator may impart a momentum that causes a localized portion of the bed solids to be preferentially accelerated, schematically illustrated as a splashzone 120 (shown only for splashgenerator 514). Splashzone 120 corresponds to a localized portion of the bed having a much higher velocity, higher magnitude, and/or otherwise faster convection than that in the surrounding bed (e.g., volatilization zone 112 and/or settling zone 122). Splashzone 120 may comprises pulsed splashes, turbulent-fluidized, fast-fluidized, and/or entrained jets of solids. For simplicity, various figures illustrate splashzone 120 as “above” the bed; it may be within the bed (although such a configuration is not readily illustrated).

A splashzone 120 may comprise a drivenflow 280 (in this case, of bed solids and char) driven by the high momentum imparted by the splashgenerator. Drivenflow 280 may comprise input flow 180, such that the splashgenerator “drives” the input flow 180 from the volatilization zone 112 to the settling zone 122. A driven flow may be used to enhance a desired flow direction and/or circulation within or between different parts of the bed. A splashgenerator may drive other flows (e.g., the output flow 380, or a flow of solids from a combustion zone to a volatilization zone).

A splashgenerator may be configured to preferentially direct a segregated species toward its preferred outlet. In FIG. 5, one or more splashgenerators 514′ may be disposed at a location (e.g., near or at the bottom) having an orientation that imparts directed momentum to enhance transport of the depleted portion of the segregated solids out of the settling zone (e.g., from right to left in FIG. 5). A splashgenerator 514″ may be disposed proximate to an expected height 213 of the settling zone (e.g., substantially parallel to the surface of the bed), and directed toward a char stream outlet. Acting preferentially on the segregated char fraction 001, splashgenerator 514′ may direct the char fraction toward the char stream outlet 119. In some cases, it may be advantageous to combine a splashgenerator 514″ configured to direct char toward the char stream outlet (FIG. 5) with a stagnant region 122′ (FIGS. 3, 4). The system may periodically create a stagnant region adjacent to the char stream outlet and splash the char fraction across the stagnant region into the char stream outlet using a splashgenerator that only imparts energy to the char stream. A splashgenerator configured to direct a char fraction may be substantially horizontally oriented, with a slightly upward angle (e.g., up to 20 degrees, including up to 10 degrees) to lift the char fraction away from the depleted portion.

Reactor 500 comprises a settling means 334 comprising a plurality of nozzles, which may be oriented at an angle and/or hooded. In this example, settling means 334 also comprises a splashgenerator 514′ configured to impart a horizontal momentum to the bed in the settling zone 122. Such a configuration may enhance the transport of the depleted portion 002 back to the volatilization zone. In this example the nozzles are partially directed toward the volatilization zone; they may be directed in other directions (e.g., away from the volatilization zone). Nozzles and/or splashgenerators may be configured to direct flow out of an outlet (not shown).

FIG. 6 is a schematic illustration of a multistage reactor comprising a settling stage and a volatilization stage, per an embodiment. Reactor 600 comprises a volatilization zone 112 and settling zone 122 within the same container 301. Two zones may share the same ambient (e.g., as volatilization zone 112 and settling zone 122 in FIG. 3). Two zones may be separated by a gaswall 302 into stages (e.g., as volatilization zone 112 and settling zone 122 in FIG. 6) such the different zones are contained within the same container (sharing the bed solids) yet have independently controllable atmospheres. In FIG. 6, a volatilization gaswall 302 separates at least a gas phase above the bed into a volatilization stage 310 (comprising the volatilization zone 112) and a settling stage 320 (comprising the settling zone 122). Separated by a gaswall, two stages (e.g., a settling stage and a volatilization stage) may have independently controlled gas compositions, pressures, temperatures, and the like.

An opening 304 below and/or through the gaswall 302 provides for fluidic communication between the beds, such that solids (e.g., including char) may move between stages. In this example, both input flow 180 and output flow 380 are shown passing through opening 304. FIG. 6 illustrates an example in which char stream outlet 119 is optional.

In reactor 600, volatilization stage 310 comprises a char precursor inlet 316 configured to deliver a char precursor to the volatilization stage. The volatilization zone 112 volatilizes the char precursor to form char, which is carried via input flow 180 to the settling zone 122. A controller 360 may be coupled to various sensors (e.g., 101, 101a-e (FIG. 1b), 350, 352, various gas inlets, gas outlets, solids outlets, splashgenerators (FIGS. 3, 4, 5), and the like). An optional depleted portion outlet 216 may be configured to convey the depleted portion 002 of bed solids from the settling stage (e.g., out of the container 301).

The bed solids in the volatilization stage may be fluidized by a flow of gas from a volatilization gas supply 311 delivered via a volatilization gas inlet 314 (e.g., a distributor, such as a distributor plate having holes distributed across the plate to fluidize the bed, a set of nozzles or tuyeres coupled to one or several gas supply headers, and the like). The volatilization gas supply 311 supplies a gas chosen according to desired volatilization conditions, precursor, desired product composition, and the like. A volatilization stage is typically operated in a highly fluidized state (e.g., at least Region 3, FIG. 2) to enhance mixing and reaction between the input precursor and the fluidization gas.

A volatilization zone may be heated with a hot gas (e.g., via a heat exchanger 340). A volatilization zone may be heated with hot solids (e.g., from a combustion zone, FIGS. 7, 8). Volatilization gas supply 311 typically supplies an inert and/or mildly oxidizing gas, although it may supply a reducing gas (e.g., H2) or an oxidizing gas (e.g., air). A volatilization zone may be operated as a combustion zone. A reactor may comprise a volatiles stream outlet 318 configured to convey a volatiles stream out of the volatilization stage.

Settling stage 320 comprises a settling zone having a settling means 334. In reactor 600, the settling means comprises a settling gas inlet 334 (e.g., a distribution pipe or sparger) coupled to a settling gas supply 331 and configured to deliver a settling gas to the settling zone 122. A settling gas outlet 328 may convey a predominantly gaseous phase from the settling zone (e.g., settling stage 320), and may be controlled by controller 360. The settling gas supply 331 may deliver the same or different gas than that delivered by the volatilization gas supply 311.

A settling gas supply may deliver a gas configured to react with one or more of the segregated species. For example, a settling gas supply 331 may deliver a gas (e.g., steam) configured to react with a segregated char to gasify the char. In some cases, over 90%, including over 95%, including over 99% of the char may be gasified, such that a char stream outlet 119 proximate to the bed height is not needed. The reaction product (e.g., syngas) may be extracted via the settling gas outlet 328. In some cases, the particle size of a segregated species (e.g., char) may be reduced throughout the course of the reaction, which may ultimately yield particles that are entrained in the gas phase; these particles may be extracted via a gas phase outlet 328. For example, char particles typically entrain at lower velocities than bed solids (and in some cases at lower velocities than ash particles). As compared to the gas phase above a fluidized bed, the gas phase above the settling zone may have very few bed solids, and may have relatively little ash. A reactor may comprise a settling gas outlet 328 having one or more separators 329 (e.g., a cyclone, a scrubber, a filter, a baghouse, an ESP) configured to separate one or more condensed species (e.g., a solid, a liquid) from a gaseous phase. A first separator may extract residual entrained (very fine) char particles, a second separator may extract fly ash, and a third separator may extract any entrained bed solids. A separator may cool the gas stream to separate permanent gases (e.g., syngas) from condensable gases.

Controller 360 may control stage pressures via one or more pressure control means (e.g., via a valve, fan, ejector, a gas inlet, an outlet, a conveyor, a screw, and the like) to achieve a desired pressure difference between adjacent stages. Controller 360 may also be coupled to various sensors to control fluidization states in the stages in response to sensor data. Controller 360 may control temperatures, fluidization states, precursor flow rates, outlet flow rates (e.g., char stream outlet, depleted portion outlet) and the like.

Sizes and flow rates may be optimized according to different reaction rates. For example, volatilization of biomass to char typically occurs rapidly, and may benefit from a high flow rate from volatilization gas supply 311. In contrast, char gasification typically proceeds slowly as compared to precursor volatilization, but requires sustained heat to maintain the reaction. A settling zone 122 may be operated such that different phases have different residence times within the zone (e.g., char remains in the settling zone until it reacts, but bed solids circulate in/out of the settling zone to maintain temperature). Operating costs may be reduced by reducing gas flow rates. For example, at equivalent pressure drops across distributors, a settling gas supply 331 may deliver a gas that is <50%, including <25%, including <10% of the velocity of the gas delivered by a volatilization gas supply 311. With a relatively lower fluidization velocity from settling gas supply 331, the (increased) cost of the extended char residence time may be offset by the (decreased) cost of providing the settling gas.

A pressure difference between stages may be used to control residence time of fuel particles (e.g., to achieve a desired reaction in the volatilization stage prior to char transfer to the combustion stage). Higher pressure in the volatilization stage may increase the net char flow rate of input flow 180, which may decrease precursor/char residence time; lower pressure typically increases residence time. A transfer of char and bed material from the volatilization to settling stages may be controlled via a sequential decrease and increase in gas pressure to “flush” char to the settling stage in waves (optionally combined with an adjustment of the char stream outlet). Char precursor residence time may also be controlled by adjusting fluidization gas velocities and/or a splashgenerator (not shown). During operation, controller 360 typically controls pressure of the volatilization stage to be different than that of the combustion stage. One or more splashgenerators (not shown) may be used to control residence time of fuel/precursor/char/bed solids in a stage.

FIG. 7 is a schematic illustration of a multistage reactor comprising a combustion stage, a volatilization zone, and a settling zone, per an embodiment. Various aspects comprise a combustion reactor configured to burn a combustion fuel to heat bed solids for use in a subsequent reactor. A reactor may comprise a combustion fuel inlet configured to deliver a combustion fuel to the reactor, and a combustion zone comprising an oxidant gas supply. The reactor may be configured to combust the combustion fuel with the supplied oxidant gas (e.g., to yield hot bed solids). The reactor may convey hot bed solids (e.g., to a settling zone and/or a volatilization zone). The reactor may receive bed solids (e.g., cold bed solids, a depleted portion of bed solids, and the like). A combustion reactor may be coupled to a volatilization zone and/or a settling zone, such that hot bed solids flow from the combustion reactor to the volatilization or settling zone. A return flow may provide for the return of cool bed solids back to the combustion reactor. A combustion reactor may comprise a bubbling fluidized bed and/or a circulating fluidized bed.

A combustion zone comprising an oxidant gas supply may be coupled to a combustion fuel inlet and configured to burn a combustion fuel with the oxidant gas to yield hot bed solids. The reactor may be configured to convey the hot bed solids to at least one of a settling zone and a volatilization zone, where they are used by the respective zone. A depleted portion of bed solids may be conveyed back to a volatilization reactor and/or a combustion reactor. A combustion zone may be contained within the same container as the volatilization and/or settling zone (typically, with a gaswall separating at least a gas phase above the bed to yield a combustion stage comprising the combustion zone). A combustion zone may be disposed as a separate reactor.

Exemplary reactor 700 comprises a container 301 containing bed solids. A combustion gaswall separates at least the gas phase above the bed into a combustion stage 330 comprising a combustion zone 332 and a stage comprising at least one (in this case, both) of a settling zone 122 and a volatilization zone 112. The combustion gaswall (in this example, a thick gaswall 302′) separates the combustion stage 330 from a combined stage 710 comprising both volatilization zone 112 and settling zone 122 (which may have the same atmosphere). An opening beneath and/or through the gaswall 302′ provides for a flow of hot bed solids from the combustion stage 330 to the combined stage 710.

The combustion stage includes a combustion fuel inlet 336 configured to deliver a combustion fuel (e.g., biomass) to the combustion zone 332 for combustion with an oxidant (e.g., air and/or oxygen) delivered by an oxidant gas supply 831. The combustion zone 332 may burn the combustion fuel to yield hot bed solids, which flow (in this case) to the combined stage 710. A combustion gas outlet 337 (e.g., controlled by controller 360) may convey combustion gases away from the combustion zone. Combustion gas outlet 337 may be coupled to a heat exchanger (e.g., HX 340, FIG. 6) to heat a gas provided by a gas inlet. The combustion zone may comprise a fluidized bed reactor (e.g., a bubbling FB) in which the bed solids are fluidized by an oxidant delivered by the oxidant inlet 834 (e.g., a distributor plate, sparger, nozzles, and the like). An oxidant may be delivered directly to the combustion zone (e.g., injected into the atmosphere, rather than via a distributor). An optional depleted portion return 837 may be coupled to a corresponding depleted portion outlet 216 to provide for circulation of the depleted portion (e.g., bed solids) from the settling zone back to the combustion zone.

In this example, combined stage 710 comprises a volatilization zone 112 configured to receive hot bed solids from the combustion zone 332. A precursor inlet (e.g., char precursor inlet 316) is configured to deliver a precursor (e.g., biomass) to the volatilization zone 112. Hot bed solids from the combustion stage may be used to volatilize the precursor to yield a product (e.g., biochar). The use of hot bed solids to drive a volatilization reaction may yield an efficient transfer of combustion heat to the char precursor, increasing system efficiency. An input flow 180 from the volatilization zone 112 to the settling zone 122 carries the solids and product to the settling zone, where they are segregated. An outlet (e.g., char stream outlet 119) may extract the product from the reactor.

The gaswall separates the gas phases above the stages and provides for the flow of bed solids between the stages (e.g., from the combustion zone 332 through and/or beneath the gaswall into the volatilization zone). Thick gaswall 302′ may comprise a thickness that is at least 20%, including at least 50%, including at least 100% of the expected fluidized bed heights on either side of the gaswall. A thick gaswall may minimize contamination of the gas phase from one stage to the other.

A reactor may comprise a gaslock 304′ configured to reduce the transport of gaseous phases between stages. A gaslock 304′ may be disposed proximate to (e.g., below) a lower edge of a gaswall. A gaslock 304′ may comprise an independently controlled gaslock gas inlet (844), which may be configured to provide for a lower fluidization state than the beds on either side. Gaslock 304′ may comprise a different distributor and/or be fluidized with a gas having a different composition than one, including both, of the zones on either side. Gaslock 304′ may comprise a portion of the bed that is barely fluidized (or even periodically non-fluidized). A gaslock may be energized at very low levels (e.g., Regime 1, FIG. 2) and may be be controlled to periodically close (e.g., with a nonfluidized bed) and open (fluidized). A gaslock may be combined with a splashgenerator oriented to direct flow in a desired direction through the gaslock. A gaslock comprising an unfluidized bed may be periodically “unlocked” by a splashgenerator imparting directed, high energy momentum through the gaslock to effect periodic transport through the gaslock.

In some cases, contamination of a gas phase does not have the same effect on two adjacent stages. For example, a combustion gas (more oxidizing than a volatilization gas) might significantly reduce the effectiveness of a volatilization stage, while a similar amount of volatilization gas might not equivalently reduce the effectiveness of the combustion stage. In such cases, the gaslock 304′ may be fluidized with a gas having a composition that is closer to that of the stage that is more sensitive to contamination (e.g., the volatilization stage). The gaslock may be fluidized with a gas that is the same as that used in a stage (e.g., a volatilization gas).

In this example, a splashgenerator 514 creates a drivenflow 280 that comprises the input flow 180 from the volatilization zone 112 to the settling zone 122. A depleted portion outlet 216 provides for the transport of the depleted portion 002 of bed solids from the settling zone 122 to the combustion zone 332.

Various reactors include one or more optional bedwalls 303 to separate at least a portion (e.g., at least a bottom) of the bed solids into different regions. A bedwall may be used to separate different zones (e.g., to reduce convection between the zones). In reactor 700, bedwall 303 is disposed between the volatilization zone 112 and settling zone 122, which may provide for increased fluidization in the volatilization zone 112 without disrupting the minimally fluidized state of the settling zone 122. A bedwall may separate a combustion zone and a volatilization zone, or a settling zone and a combustion zone. A bedwall may be advantageous in combination with a splashgenerator configured to generate a drivenflow 280 that flows past (e.g., over) the bedwall, as in reactor 700. In this example, a top of bedwall 303 is below the height of char stream outlet 119; it may be above.

FIG. 8 is a schematic illustration of a reactor comprising a settling zone and a separate reactor comprising a combustion zone, per an embodiment. A reactor may comprise a discrete combustion reactor separate from the container comprising a settling zone and/or volatilization zone. Hot bed solids may be conveyed to the reactor comprising the volatilization/settling zone, and used bed solids (e.g., a depleted portion of the bed solids) may be conveyed back to the discrete combustion reactor.

In exemplary FIG. 8, reactor 800 comprises a container 301 configured to contain a volatilization zone 112 and a settling zone 122. Container 301 is coupled to a discrete combustion reactor 802 comprising a combustion fuel inlet 336 and a combustion zone 832 configured to combust a combustion fuel (e.g., to heat bed solids). An exemplary reactor 802 may comprise the combustion zone 832 configured as a circulating fluidized bed reactor. An oxidant inlet 834 may fluidize the bed solids in the combustion zone 832 using an oxidant from an oxidant gas supply 831 (e.g., with turbulent fluidization, fast fluidization, and/or pneumatic transport).

The combustion zone may be fluidically coupled to the volatilization zone to provide for the flow of hot bed solids from the combustion zone to the volatilization zone (e.g., via a hot solids outlet 836 from the combustion zone to a hot solids inlet 816 to the volatilization zone). With a reactor 802 that is discrete from container 301, hot solids outlet 836 and hot solids inlet 816 may be coupled by a suitable pipe or other passage (e.g., including a riser or other pneumatic transport path).

Combustion reactor 802 may burn combustion fuel received via the combustion fuel inlet 336 to yield hot bed solids. The hot solids may be used (e.g., in volatilization zone 112) to react a precursor received via a precursor inlet (e.g., char precursor inlet 316). The reaction product (e.g., biochar) may flow to the settling zone 122 via input flow 180, where it is segregated by the settling means 334. An outlet (e.g., char stream outlet 119) may extract the segregated phase (e.g., char). A depleted portion outlet 216 may provide for the transport of the depleted portion 002 of bed solids from the settling zone 122 to the combustion zone 332.

The combination of a settling zone with a circulating fluidized bed reactor (CFB) as a combustion reactor and/or a volatilization reactor may enable the use of bed solids that are optimized for both reaction and settling. In an embodiment, a discrete circulating fluidized bed reactor 802 comprising combustion zone 832 (e.g., comprising Geldart A bed solids) is coupled to a separation reactor comprising settling zone 122 comprising a gas inlet 334. The gas inlet may be operated to fluidize the bed within the settling zone at a superficial gas velocity that is at least Umf but does not exceed Umb. The settling zone may benefit from bed solids comprised of at least 20% Geldart A solids, including at least 40%, including at least 60%, including at least 80%, including at least 90%, including at least 99%, which may facilitate the avoidance of bubbling fluidization in the settling zone.

In an embodiment, a reactor combines a discrete combustion reactor 802 configured as a first circulating fluidized bed reactor, (FIG. 8) coupled to a discrete volatilization reactor 402 configured as a second circulating fluidized bed reactor, which is coupled to a settling zone 122. (FIG. 4) Hot bed solids from the first CFB may be used by the second CFB to volatilize a char precursor to yield char, which is conveyed via input flow 180 to a settling zone 122, from which the char is separated and removed from the reactor. Bed solids may flow from the settling zone back to the first CFB.

FIG. 8 illustrates an optional baffle (305), which may be disposed proximate to the height of the char fraction and configured as a “fence” around the segregated char to keep it in a desired location (e.g., near a char stream outlet and/or to prevent the segregated char from flowing back toward another zone, such as volatilization zone 112). A baffle may retain the char fraction while still allowing the input flow 180 and/or depleted portion 002 to pass. A splashgenerator (not shown, e.g., FIG. 7) may be combined with a baffle, e.g., such that an input flow 180 is splashed over and/or under the baffle into the settling zone 122. A baffle may be disposed at an approximate height of the bed solids (e.g., proximate to an expected height of the char fraction in the settling zone), such that the baffle preferentially blocks segregated char fraction 001 while allowing bed solids (e.g., depleted portion 002) to pass. A distance between the top and bottom of the baffle may be chosen according to an expected depth of the char fraction. The top and/or bottom of the baffle may be located above or below or approximately at an expected height of a char stream outlet 119. A baffle may guide the char fraction toward the char stream outlet.

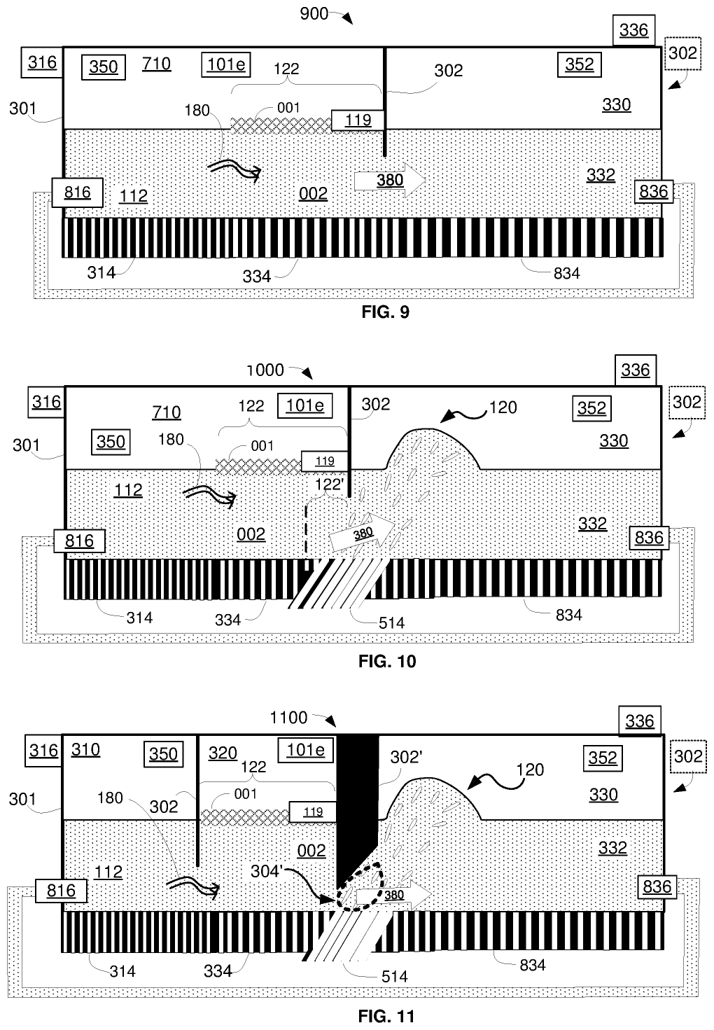

FIG. 9 is a schematic illustration of a multistage reactor, per an embodiment. Reactor 900 comprises a char stream outlet 119 oriented orthogonal to a flow of solids through the reactor (directed “out of the page” in this illustration). A hot solids outlet 836 conveys hot solids from the combustion zone 332 to the volatilization zone 112 via a hot solids inlet 816 to the volatilization zone. Inlets and outlets are shown schematically to illustrate flow direction on a flat page. A reactor may comprise distinct structural inlets and outlets (e.g., 836, 816). Inlets and outlets may comprise openings between stages. For example, reactor 900 may be configured circularly, in which the right side of the reactor comprises a combustion gaswall 302 separating the combustion stage and the combined stage 710, and the solids outlet 836 and solids inlet 816 comprise an opening below/through the combustion gaswall 302. FIG. 9 illustrates a stagnant zone 122′ disposed adjacent to a gaswall 302 (which may comprise a gaslock, not shown). Splashgenerator 514 may periodically impart directed, high momentum velocity to the bottom of the stagnant zone 122′ such that bed solids are driven out of the stagnant zone (in this case, into the combustion zone 332).

FIG. 10 is a schematic illustration of a multistage reactor, per an embodiment. Reactor 1000 may comprise a splashgenerator 514 configured to generate a drivenflow 120 of bed solids from the settling zone 122 to the combustion zone 332. Such a configuration may increase the flow rate of an output flow 380 of the depleted portion 002 of bed solids from the settling zone 122 to another zone (in this case, the combustion zone 332). Splashgenerator 514 may comprise a transport gas that is compatible with (e.g., similar to, or even the same as) the gas used in the receiving zone (here, the combustion zone).

FIG. 11 is a schematic illustration of a multistage reactor, per an embodiment. Reactor 1100 comprises three stages disposed in container 301 and separated by two respective gaswalls. A volatilization gaswall 302 may separate a volatilization stage 310 from an adjacent stage (in this example, a settling stage 320). A settling gaswall (in this example, a thick gaswall 302′) may separate the settling stage 320 from an adjacent stage (in this example, a combustion stage 330).

A thick gaswall 302′ may comprise a lower surface having a shape that facilitates flow in a desired direction (e.g., from one stage to the next stage). In reactor 1100, thick gaswall 302′ includes an angled bottom surface that is lower proximate to the settling stage than it is proximate to the combustion stage (the bottom surface is “angled upward,” here toward the combustion stage) such that rising bubbles or splashgenerator momentum is directed in a desired direction. Such a configuration may enhance solids transport yet still minimize gas phase contamination. Reactor 1100 illustrates a combination of such a gaswall with a gaslock 304′. In this example, gaslock 304′ comprises a splashgenerator 514, which may be controlled to combine periods of time with low fluidization velocity (closing the gaslock) with periodic splashes of high fluidization velocity (opening the gaslock). Pulsed flow may be advantageous when accelerating the mildly fluidized bed of the settling stage into the highly fluidized bed of the combustion stage. In this example, an injection angle of the splashgenerator is substantially parallel to (e.g., is within 10% of) the lower surface of the thick gaswall 302′.

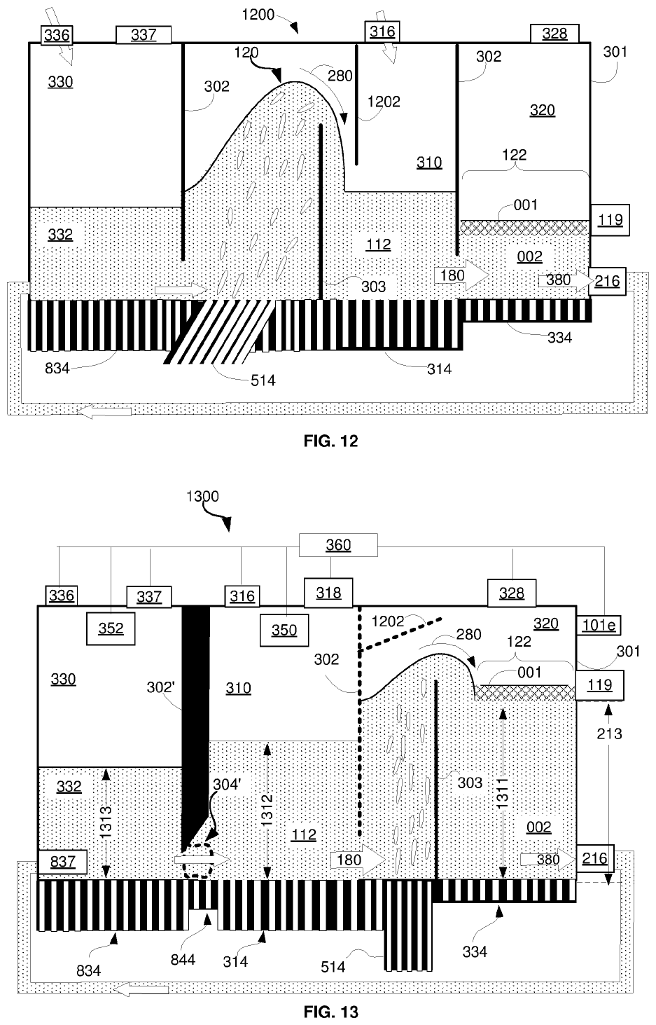

FIG. 12 is a schematic illustration of a multistage reactor, per an embodiment. Reactor 1200 comprises a splashgenerator 514 disposed between a gaswall 302 and a bedwall 303. In this example, a first gaswall 302 separates the combustion stage 330 and the volatilization stage 310, and a second gaswall 302 separates the volatilization stage 310 and the settling stage 320. In this example, the splashgenerator creates a drivenflow 280 of hot solids from the combustion zone 332 to the volatilization zone 112. Splashgenerator 514 may comprise a transport gas that is compatible with (e.g., similar to, or even the same as) the gas used in the volatilization zone. The transport gas delivered used by the splashgenerator may be heated (e.g., via a heat exchanger 340, FIG. 6) to increase or maintain the temperature of the hot bed solids conveyed to the volatilization zone. In this example, a bottom of the gaswall 302 between the volatilization stage 310 and the settling stage 320 is below the height of the char stream outlet 119.

FIG. 13 is a schematic illustration of a multistage reactor, per an embodiment. Reactor 1300 comprises a splashgenerator 514 that creates a drivenflow 280 comprising the input flow 180 of solids and volatilization product (e.g., char). Splashgenerator 514 (in this example, oriented predominantly vertically) may comprise a transport gas that is compatible with (e.g., similar to, or even the same as) the gas used in the settling zone. An optional gaswall 302 may separate the volatilization and settling zones into a volatilization stage 310 and settling stage 320, respectively. In some embodiments, a gaswall 302 between a volatilization stage and a settling stage is not needed. A bedwall or gaswall or baffle may enhance the performance of a splashgenerator by directing splashed solids in a desired direction. In this example, a top of bedwall 303 is disposed above the height of the char stream outlet 119.

An optional angled internal wall 1202 may be disposed above the splashgenerator and configured to direct a drivenflow 280 in a desired direction (e.g., toward the settling zone 122. An internal wall may be disposed as a baffle (e.g., within a bed, including at least partially above the bed) that inhibits solids flow proximate to the baffle.

Pressures of the individual stages may be controlled independently, which may facilitate a desired flow rate (e.g., of solids and/or char) between each of the stages. In an embodiment, combustion stage 330 is operated at a first pressure (as represented by combustion bed height 1313), volatilization stage 310 is operated at a second pressure (as represented by volatilization bed height 1312) and (with gaswall 302) the settling stage 320 is operated at a third pressure (as represented by settling bed height 1311). A pressure difference or other driving force between depleted portion outlet 216 and depleted portion return 837 may be used to drive the depleted portion from the settling stage to the combustion stage. Flow from the combustion stage to the volatilization stage and/or from the volatilization stage to the settling stage may be created by a suitably oriented splashgenerator 514 configured to direct flow in the desired direction. In this example, splashgenerator 515 imparts a momentum that directs solids from a stage having lower pressure to a stage having higher pressure.

FIG. 14 is a schematic illustration of a reactor, per an embodiment. A bedwall 303 may be disposed within a settling zone 122, separating at least some of the depleted portion from the char stream outlet 119. In FIG. 14, bedwall 303 separates a stagnant region 122′ from another part of the settling zone 122 such that the more-fluidized depleted portion 002 is preferentially prevented (or at least hindered) from approaching the char stream outlet 119. For example, a height of the bedwall 303 as compared to an expected height of the depleted portion 002 may be chosen such that the depleted portion 002 is blocked by the bedwall 303, but the char fraction 001 may pass over the bedwall 303. In some cases, the height 213 (FIG. 1A) of the settling zone 122 may be controlled such that the char fraction preferentially traverses the bedwall, while the depleted portion does not. A stagnant region 122′ proximate to the char stream outlet may provide for sufficient energy that the char fraction 001 exits the char stream outlet but the depleted portion 002 does not contaminate the char stream outlet. Char stream outlet 119 may be disposed (or adjusted) to be above an expected top surface of the depleted portion 002 yet below an expected top of the char fraction 001. Continual replenishment of the char fraction may drive the char out of the char stream outlet. FIG. 14 illustrates an optional configuration in which height of the bed (e.g., depleted portion 002) proximate to the char stream outlet is lower than the corresponding height on the “upstream” side (e.g., left in FIG. 14) of bedwall 303, which may enhance flow of the char fraction over the bedwall (e.g., out of the char stream outlet).

A stagnant region may comprise a depleted portion outlet 216 disposed below a bottom of another portion of the bed, such that bed solids may exit the stagnant region from below. The configuration shown in FIG. 14 may be combined with various other options (e.g., a splashgenerator (FIGS. 3, 4, 5) a canted wall 111 (FIG. 1C) a gaswall (FIG. 6), a tapered wall 301′ (FIG. 1D) and the like. The reactor may be operated such that the substantially the entire bed to the left of the bedwall 303 is operated as a volatilization zone, and the bed to the right of bedwall 303 is operated as a stagnant region 122′ (e.g., the portion of the settling zone to the left of the bedwall may be omitted).

A reactor may comprise a settling zone configured to receive an input flow comprising at least first and second types of particles. The settling zone may comprise a settling means configured to segregate the input flow into phases (e.g., a bed comprising respective layers of the first and second phases). A first phase may be enriched in the first particles and depleted in the second particles. A concentration of first particles in the first phase may be at least 5× larger than the concentration of first particles in the second phase. The first and second phases may be extracted from the reactor and/or reacted within the reactor.

Various features described herein may be implemented independently and/or in combination with each other. An explicit combination of features in an embodiment does not preclude the omission of any of these features from other embodiments. Features described in separate embodiments may be combined, notwithstanding that their combination is not explicitly recited as such. The above description is illustrative and not restrictive. Many variations of the invention will become apparent to those of skill in the art upon review of this disclosure. The scope of the invention should, therefore, be determined not with reference to the above description, but instead should be determined with reference to the appended claims along with their full scope of equivalents.

1-28. (canceled)

29. A continuous char separation reactor (100, 110, 300, 400, 500, 600, 700, 800, 900, 1000, 1100, 1200, 1300, 1400) comprising:
a container (301) configured to contain a bed of char and bed solids;
a char precursor inlet (316);
a volatilization zone (112, 412) coupled to the char precursor inlet (316) and comprising the bed solids and a volatilization gas inlet (314), the volatilization zone configured to:
receive a char precursor via the char precursor inlet (316); and
volatilize the char precursor with a volatilization gas to form the char;
a settling zone (122) coupled to the volatilization zone and configured to receive an input flow (180) comprising the char and bed solids, the settling zone (122) comprising:
a settling gas inlet (334) coupled to a settling gas supply (331) and configured to fluidize the setting zone at a fluidization number (U/Umf) below 3 to segregate the received char and bed solids into:
a char fraction (001) having a ratio of char to bed solids that is at least 10× larger than that of the input flow (180); and
a depleted portion (002) of the bed solids having a lower ratio of char to bed solids than that of the input flow.

30. The reactor of claim 29, further comprising a char stream outlet (119) fluidically coupled to the settling zone (122) and configured to convey at least a portion of the char fraction (001) from the settling zone (122).

31. The reactor of claim 29, wherein the settling gas inlet is configured to fluidize the settling zone at a fluidization number (U/Umf) that is not more than 2.0.

32. The reactor (300) of claim 29, wherein the settling zone (122) is disposed within a first region of the container, the volatilization zone (112, 412) is disposed within a second region of the container, and the volatilization gas inlet (314) is configured to fluidize the bed solids in the volatilization zone as a bubbling fluidized bed.

33. The reactor (400) of claim 29, wherein:
the volatilization reactor comprises a discrete volatilization reactor (402); and
the settling zone comprises a depleted portion outlet (216) coupled to the discrete volatilization reactor (402) and configured to convey the depleted portion (002) from the settling zone (122) to the discrete volatilization reactor (402).

34. The reactor of claim 33, wherein the discrete volatilization reactor comprises a circulating fluidized bed reactor.

35. The reactor (300, 500, 600, 700, 800, 900, 1000, 1100, 1200, 1300, 1400) of claim 29, further comprising a pressure sensor (101a, 101b, 101c, 101d, 101e) configured to measure at least one of:
a first pressure drop (101a-101b) across the settling gas inlet (334); and
a second pressure drop (101b-101e) between a bottom of the settling zone (122) and a gas phase above the settling zone (122).

36. The reactor of claim 29, further comprising:
a sensor (101, 101a, 101b, 101c, 101d, 101e) configured to measure a parameter that is indicative of performance of the settling zone (122); and
a controller (360) coupled to the sensor and the settling gas inlet, the controller configured to:
receive a value of the measured parameter from the sensor;
calculate a difference between the received value and a desired value;
compare the difference to an acceptable difference; and
operate the settling gas inlet to reduce the difference between the present and desired values when the difference is greater than the acceptable difference.

37. The reactor (700, 800, 900, 1000, 1100, 1200, 1300, 1400)) claim 29, further comprising:
a combustion fuel inlet (336) configured to deliver a combustion fuel to the reactor; and
a combustion zone (332, 832) comprising an oxidant gas supply (831) and configured to:
receive the depleted portion (002) of the bed solids
combust the combustion fuel with a supplied oxidant gas to yield hot bed solids; and
convey the hot bed solids to at least one of the settling zone (122) and the volatilization.

38. The reactor (700, 900, 1000, 1100, 1200, 1300, 1400) of claim 37, wherein the combustion zone (332) is contained within the container (301), and the reactor further comprises a combustion gaswall (302, 302′) configured to separate at least a gas phase above the bed into:
a combustion stage (330) comprising the combustion zone (332); and
a stage (310, 320) comprising at least one of the volatilization zone (112) and the settling zone (122).

39. The reactor (800) of claim 37, further comprising:
a discrete combustion reactor (802) comprising the combustion zone (832); and
a depleted portion outlet (216) coupled to the settling zone (122) and configured to convey the depleted portion (002) of the bed solids from the settling zone (122) to the discrete combustion reactor (802).

40. The reactor of claim 39, wherein the discrete combustion reactor (802) comprises a circulating fluidized bed reactor.

41. The reactor (100, 110, 300, 400, 500, 600, 700, 800, 900, 1000, 1100, 1200, 1300, 1400) of claim 30, wherein the settling gas inlet (134, 334, 434, 414, 514′) is configured to generate a stagnant region (122′) proximate to the char stream outlet (119).

42. The reactor of claim 41, wherein the settling gas inlet (334) is configured to deliver a settling gas to the stagnant region (122′) at a fluidization number (U/Umf) that does not exceed 0.8.

43. The reactor of claim 41, wherein the stagnant region (122′) comprises a static bed.

44. The reactor of claim 29, further comprising at least one splashgenerator (414, 514′) comprising aligned jet nozzles coupled to a transport gas supply and configured to impart a directed, aligned momentum to the depleted portion (002).

45. The reactor of claim 29, wherein the settling gas supply (331) is further configured to gasify at least a portion of the char.

46. The reactor of claim 30, further comprising a baffle (305) disposed proximate to an expected height of the char fraction (001) and configured to retain the char fraction (001) in the settling zone (122) and/or guide the char fraction (001) toward the char stream outlet (119).

47. A method comprising:
providing a reactor comprising a char precursor inlet (316) and bed solids;
receiving a char precursor via the char precursor inlet;
volatilizing the char precursor with a volatilization gas to form char;
conveying an input flow (180) comprising the char and bed solids to a settling zone (122);
settling the input flow (180) to segregate the char and bed solids into:
a char fraction (001), having a ratio of char to bed solids that is at least 10× larger than that of the input flow (180); and
a depleted portion (002) having a smaller ratio of char to bed solids than that of the input flow (180);
and at least one of:
extracting at least a portion of the char fraction (001) via a char stream outlet (119); and
gasifying at least a portion of the char fraction (001).

48. A continuous char separation reactor (100, 110, 300, 400, 500, 600, 700, 800, 900, 1000, 1100, 1200, 1300, 1400) comprising:
a container (301) configured to contain a bed of char and bed solids;
a char precursor inlet (316);
a volatilization zone (112, 412) coupled to the char precursor inlet (316) and comprising the bed solids, the volatilization zone configured to:
receive a char precursor via the char precursor inlet (316); and
volatilize the char precursor with the bed solids to form the char;
a settling zone (122) coupled to the volatilization zone and configured to receive an input flow (180) comprising the char and bed solids, the settling zone (122) comprising an actuator configured to impart mechanical energy to the settling zone to segregate the received char and bed solids into:
a char fraction (001) having a ratio of char to bed solids that is at least 10× larger than that of the input flow (180); and
a depleted portion (002) of the bed solids having a lower ratio of char to bed solids than that of the input flow.
